(19) United States
(12) Patent Application Publication
(10) Pub. No.: US 2002/0082863 A1
(43) Pub. Date: Jun. 27, 2002

(54) Systems and methods for obtaining approval for medical reimbursements

(76) Inventor: John D. Kleinke, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/747,614

(22) Filed: Dec. 21, 2000

(51) Int. Cl. G06F 17/60

(52) U.S. Cl. 705/2

(57) ABSTRACT

Systems and methods for requesting and providing payer attributes corresponding to a medical treatment. The payer attributes can include procedures and/or documents necessary to secure payment for a medical treatment from the payer. The methods comprise receiving an indicator from a user node at a system node and determining payer attributes based on the indicator. The payer attributes are communicated to the user across a computer network. The systems comprise a system node associated with a database and in communication with the Internet. The database embodies at least one interactive request for approval of a medical treatment.

### BACKGROUND OF THE INVENTION

This invention relates in general to approval and payment systems in the Health Care Industry. More specifically, this invention relates to organizing and distributing third party payer information and to obtaining treatment approvals from third party payers.

There is a desire to streamline mechanisms for obtaining approval and reimbursement from third party payers for health care treatments. The third party payers include, but are not limited to, Health Maintenance Organizations, Preferred Provider Networks, Third Party Administrators, Medicare, Medicaid, and other insurance organizations. The complexity and resistance of the current approval and reimbursement mechanisms causes many health care providers to elect more common and cheaper, yet less effective treatments to avoid problems getting approvals and potential losses associated with denials. Because of the complexity and resistance of the existing approval and reimbursement system, payers have significant, indirect control over patient treatment. At times, system complexity results in a care provider selecting a less costly treatment capable of providing results equivalent to a more costly treatment. However, too often, a less costly treatment is selected which is less effective both in terms of costs and health.

The July 1999 Kaiser Family Foundation/Harvard School of Public Health, Survey of Physicians and Nurses found that sixty-three percent of appeals to payers resulted in approval for a previously denied treatment alternative. This statistic suggests that over half of the denials are unwarranted. In fact, some suggest that third party payers have deliberately constructed an overly complex approval and reimbursement system to force health care providers to elect less expensive, more commonly approved treatments, rather than an optimal treatment plan. In this way, the payer gains by reducing expenditures for treatment.

Further, a payer increases profits even where a health care provider appeals a denial and the optimal treatment is ultimately approved by the payer. These increased profits derive from delaying payment for the optimal treatment while the appeal process drags on. While these increased profits are good for the payer, they are obtained at the expense of the patient and the health care provider. For example, in a typical appeal of denial where the optimal treatment is ultimately approved, there is a ten to twelve day delay in the treatment and/or payment for the treatment. This delay is costly to the patient and health care provider. The costs are often financial for the provider and health related to the patient. In fact, the same Kaiser study suggests that between one-third and two-thirds of denials result in a “serious” decline of the patients health status.

Time spent by the health care industry appealing unwarranted denials ultimately increases costs of health care. In part, the skyrocketing costs of health care are due to the complexities of the approval and reimbursement system. Further, the complexities greatly diminish the efficiency of the industry by causing health care providers to be preoccupied with treatment reimbursement and approval issues rather than their patients.

If unwarranted denials were infrequent, the denial problem possibly would be tolerable, however, denials are common. The Kaiser study found that sixty-one percent of the professionals surveyed were denied approval for a selected prescription drug on a weekly basis. In contrast, only eight percent of those surveyed never experienced a similar denial. Thus, not only do unwarranted denials result in financial and physical detriments to both patients and providers, the high frequency of such denials result in extraordinary financial and physical detriment.

The complexity of the approval and reimbursement system is in part due to the complicated and disparate nature of the health care industry. The complicated nature of the health care industry is largely due to a rapid expansion of health related knowledge which is driven by forty billion dollars a year in research and development spending. This rapid expansion of knowledge makes health care services one of the most complex products of our economy.

Additionally, and perhaps more important, the health care industry is driven by thousands of independent professionals each having a unique system developed for the particular needs of both themselves and their patients. Even where health care professionals form partnerships, they are often no more than a loose collection of professionals rather than a single entity. As a consequence, health providers use thousands of unrelated mechanisms, computer systems, and proprietary software packages for processing and recording payments for services from both patients and payers. Often, the systems are rudimentary, relying on manual action by the health care provider and other office staff.

Even where computer systems are utilized to reduce reimbursement and approval complexity, they often are incompatible with other systems due to proprietary software developed to meet unique requirements of each health care provider. Further, these computer systems inevitably are coupled with paper such as medical records, prescriptions, appeals forms, approval forms, reimbursement forms, telephone message slips, faxes, and bills. Thus, as discussed in the inventor's article, “Clinical Information Technology in the Real World,” Health Affairs (November/December 1998):23-38, J. D. Kleinke notes that development of efficient systems for the health care industry has been deeply troubled.

Other problems affecting efficiency include the very private nature of the information. Without doubt, personal medical information is some of the most private information available. Thus, broad use of computer systems are hindered by fear of exposing private medical information. Additional problems include non-standard terminology which increases in step with the growth of health care knowledge.

Thus, there exists a need for systems and methods for streamlining the approval and reimbursement process.

### SUMMARY OF THE INVENTION

The present invention provides direct, universal access to payer attributes related to a particular treatment. The payer attributes can be used to secure approval for health care treatments and/or appeal coverage denials. Further, the present invention supports reimbursement for specific treatments by interfacing with reimbursement support groups. The interface with the support groups may be provided through secure Reimbursement Desktops. In some embodiments, the Reimbursement Desktop is developed for, and operated in conjunction with the support groups.

Embodiments of the present invention include methods for providing a payer attribute corresponding to a medical treatment. The methods comprise receiving an indicator at a system node. A payer attribute is determined from the indicator and communicated to a user node across a computer network. In some embodiments, the indicator identifies a treatment and/or a payer, and the payer attribute comprises a diagnosis which supports the treatment and/or a payer requirement for approving the treatment. The treatment can be a medication and/or a medical procedure.

Some embodiments of the methods include providing a system node associated with a computer readable medium. The computer readable medium comprises treatment data associated with a treatment identifier, payer data associated with a payer identifier, and a payer attribute associated with a combination of the treatment identifier and the payer identifier. In some embodiments, the computer readable medium further comprises a first statistical datum associated with a payer identifier and a second statistical datum associated with a medication identifier.

Embodiments of the methods include providing interfaces for ordering medications, creating approval requests, and/or appealing denials of treatments. The interfaces can be interactive letters, form letters, or other interfaces for receiving user data.

Some embodiments of the methods comprise receiving a request for access from a provider. The identity of the requesting provider is given to a treatment supplier, which can supply the provider with a password.

Yet another embodiment of the present invention is a system for securing approval for a medical treatment from a payer. The system comprises a system node associated with a computer readable medium. The system node is in communication with the Internet and the computer readable medium embodies an interactive request for approval of a medical treatment. In some embodiments, the interactive request for approval is an interactive letter.

These and other embodiments of the present invention are described in more detail in conjunction with the text below and attached figures.

### BRIEF DESCRIPTION OF THE DRAWINGS

A more complete understanding of the present invention may be derived by referring to the detailed description and claims when considered in connection the Figures, wherein like reference numbers refer to similar items throughout the Figures, and:

FIG. 1 is a block diagram of an embodiment of a system according to the present invention;

FIG. 2 is a block diagram of an embodiment of a database interface;

FIG. 3 is a screen view of an interface for the system illustrated in FIG. 1;

FIGS. 4A-4B are sequential portions of a screen view prompting for provider information input for the system illustrated in FIG. 1;

FIGS. 5A-5C are sequential portions of a screen view providing treatment information and additional system access for the system illustrated in FIG. 1;

FIGS. 6A-6B are sequential portions of a screen view providing commercial treatment information for the system illustrated in FIG. 1;

FIG. 7 is a Letter of Medical Necessity for a Treatment for the system illustrated in FIG. 1;

FIG. 8 is a screen view of an Interactive Letter for the system illustrated in FIG. 1;

FIG. 9 is a screen view of a prompt for payer information for the system illustrated in FIG. 1;

FIG. 10 is a screen view of payer information including hyperlinks to additional information for the system illustrated in FIG. 1;

FIGS. 11A-11B are portions of a pre-authorization letter for a specific payer for the system illustrated in FIG. 1;

FIG. 12 is a screen print of a Reimbursement Desktop for insured patients and a specific treatment for the system illustrated in FIG. 1;

FIGS. 13A-13B are portions of a screen print of an insurance verification entry page for the system illustrated in FIG. 1;

FIG. 14 is a screen print of an insurance verification confirmation for the system illustrated in FIG. 1;

FIG. 15 is a screen print of a treatment shipment authorization for the system illustrated in FIG. 1;

FIG. 16 is a screen print of a Reimbursement Desktop for uninsured patients and a specific treatment for the system illustrated in FIG. 1;

FIGS. 17A-17D are portions of a screen print of a prompt for patient assistance program verification for the system illustrated in FIG. 1;

FIG. 18 is a screen print of a prompt for providing information for a patient assistance program acceptance e-mail message for the system illustrated in FIG. 1;

FIG. 19 is a screen print of a prompt for providing information for a patient assistance program denial e-mail message for the system illustrated in FIG. 1;

FIG. 20 is a screen print of a prompt for providing information for a product shipment authorization for the system illustrated in FIG. 1;

FIG. 21 is a screen print of a Reimbursement Desktop providing additional information on claims assistance for a specific product for the system illustrated in FIG. 1; and

FIG. 22 is a screen view of a prompt for payer information for the system illustrated in FIG. 1.

### DESCRIPTION OF THE SPECIFIC EMBODIMENTS

The present invention provides systems and methods for securing approval and/or reimbursement for health care treatments from third party payers. The systems and methods operate to streamline and simplify patients' access to treatments their care providers believe they should be receiving. More specifically, in some aspects, the present invention provides efficient systems and methods for foreseeing an approval and/or denial of a treatment authorization request by a third party payer, requesting approval for a treatment, appealing any denial of approval, and receiving approval to provide a previously denied treatment. Said another way, the present invention advantageously accelerates the reimbursement compliance process. In some embodiments, the treatment includes a combination of a prescription drug and a medical procedure, or just a medical procedure or a prescription drug.

In general, third party payers, or just payers, are health insurance companies. However, a payer can be any party from which payment for products or services is solicited.

As used in this Application, a payer attribute is any attribute of a payer related to obtaining approval and/or reimbursement for a health care treatment. A payer attribute includes a payer's approval requirements including, but not limited to, particular diagnosis or indicia required before payment for a particular treatment will be approved, or even a type of provider which can be approved to receive payment for a particular treatment. Additionally, a payer attribute can include a payer's procedures and paperwork required for obtaining approval and/or reimbursement. A payer's procedures can be as simple as providing contact information for communicating with the payer, such as a payer's address, or as complicated as requiring submission of a series of patient tests and corresponding Letters of Medical Necessity (LMN). Alternatively, the procedures may outline a process for obtaining payment pre-authorization for a treatment or for appealing a denied request for payment and/or approval. In some instances, a payer attribute includes a substitute treatment corresponding to a prescribed or otherwise desired treatment. The suggested substitute treatment can include an explanation of the reason for the substitution such as equivalence between treatments and/or a cost based justification for the substitute. Further, an attribute can include a description of any reimbursement differentials between a prescribed or desired treatment and a suggested substitute treatment. It should be noted that a payer attribute can include any single payer related requirement, or a combination of requirements.

Before describing details of the present invention, a general overview is provided. In one embodiment of the present invention, a physician prescribes a leading-edge therapy that usually requires pre-authorization. In some instances, the prescribed therapy may have less expensive, yet clinically sub-optimal substitutes. For example, the medication KYTRIL™ has a generic substitute called Compazine, which is often less effective for treating chemotherapy related nausea. In other instances, the prescribed therapy is considered by payers as only marginally beneficial for large groups of patients. Thus, for example, the medication LEUKINE™ is typically only approved for a patient with a white blood cell count in the “gray” areas and not for other patients.

Through a variety of mechanisms, depending on the treatment and the payer, the payer may request information for pre-authorization for the treatment, deny reimbursement for the prescribed treatment by switching it to a sub-optimal treatment, or deny reimbursement for any treatment altogether.

The health care provider (i.e., the physician) chooses either to submit the additional documentation for pre-authorization, surrender to the denial, or appeal the denial. Such appeals are often made by a physician's office with the assistance of a product manufacturer/marketer or an outsourced reimbursement support vendor. Without the present invention, such appeals are a manual, time-consuming process informed only by previous experience or by trial-and-error learning of the process with the payer.

For pre-authorization, a physician's office will need to document the clinical rationale for a particular treatment choice. Usually such rationale include the failure of a less expensive therapy, a risk of complications associated with a less expensive therapy, or other clinical factors. For a “switched” product or treatment, the appeal typically documents the clinical inappropriateness of the switch, given elements of the patient's particular disease status, vulnerability to associated complications, etc. For example, a health care provider may need to document a patient's history of gastrointestinal problems to gain approval to prescribe KYTRIL™. For a “marginal” product, such as NEUPOGEN™, appeals typically need to document specific clinical factors, such as a the patient's actual white blood cell count, to gain approval to prescribe the product or treatment. Again, without the present invention, the entire process is labor-intensive and complicated.

Using the present invention, a health care provider, their office staff, a patient, a manufacturer and/or supplier of a particular treatment, or even a payer has immediate and universal access to tools for quickly and easily submitting information to gain pre-authorization for a treatment or to appeal a denial of a treatment. In accordance with one embodiment of the present invention, three service levels, Basic, Expanded and Reimbursement Desktop, may be provided. Under the Basic service level, the reimbursement and approval process is supported by general information and the customizable LMN or other documentation provided through the present invention. Under the Expanded service level, the reimbursement and approval process is supported further by payer-specific, product-specific information and documentation. Through additional development and deployment of custom, secure Reimbursement Desktops, the reimbursement and approval process may be fully integrated into reimbursement support systems provided by manufacturers, suppliers, payers, and others.

In addition to its core reimbursement support functionality, the present invention also serves as a focused patient educational resource. This resource includes extensive content, written in lay language, describing how drug benefits are actually administered, the differences between medical and prescription benefits, the uses of specific drug products, drug benefit policy debates, etc.

Preferably, the methods, systems and techniques of the present invention are provided in relation to the Internet where groups of individuals access shared data files. However, one skilled in the art would recognize many other networks and/or communication means which could be used in relation to the present invention. For example, networks, such as LANs, WANs, intranets, and the like, can be used in relation to the present invention.

In the Figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

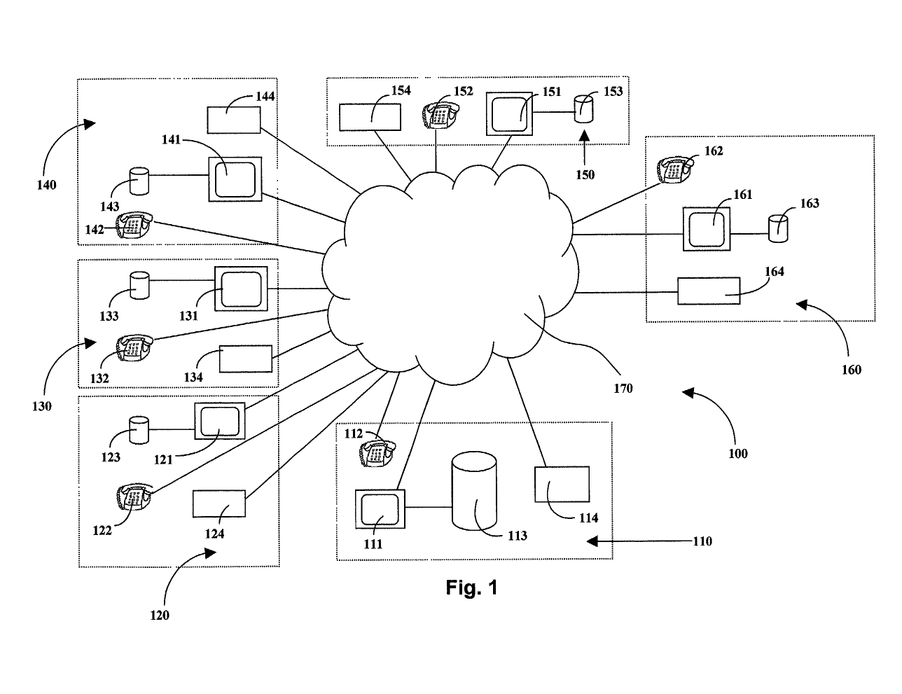

Referring to FIG. 1, a system 100 in accordance with one embodiment of the present invention includes a system facility 110, a provider facility 120, a patient facility 130, a pharmacy facility 140, a reimbursement consultant facility 150, and a payer facility 160. Each of the facilities 110, 120, 130, 140, 150 and 160 are connected by a network 170. Network 170 is any network or combination of networks capable of transferring information. In some embodiments, network 170 is a combination of a telephone and computer network. In a preferred embodiment, network 170 is a combination of the Internet and a telephone network. As one skilled in the art will appreciate, the Internet also can facilitate the telephone network.

In one embodiment of the present invention, provider facility 120 is located at a physician's office, patient facility 130 is located at a patient's home, pharmacy facility 140 is located at a pharmacy, reimbursement consultant facility 150 is located at a workstation of a reimbursement consultant provided by a manufacturer or supplier of a medical treatment, and payer facility 160 is located at an insurance company.

Each of the facilities 110, 120, 130, 140, 150 and 160 include a computer terminal (111, 121, 131, 141, 151, and 161, respectively), a telephone (112, 122, 132, 142, 152, and 162, respectively), a database (113, 123, 133, 143, 153, and 163, respectively), and a facsimile machine (114, 124, 134, 144, 154, and 164, respectively). A computer terminal can be a personal computer, a server, a network of computers, or any other terminal capable of performing functions according to the present invention. At times, computer terminals 111, 121, 131, 141, 151, and 161 are referred to as nodes. Further, user nodes and system nodes can be distinguished. A user node is any computer terminal used by a user to obtain approval and/or reimbursement from a payer. In contrast, a system node is any node used to provide approval and/or reimbursement information. Accordingly, computer terminals 111 and 161 are generally system nodes, while computer terminals 121 and 131 are generally user nodes. In some embodiments, a computer terminal may provide dual uses and would thus be both a system and user node.

It should be recognized that any number of facilities 110, 120, 130, 140, 150 and 160 can be included to form system 100. For example, in one embodiment, system 100 includes: a single system facility 110, multiple patient facilities 130, multiple provider facilities 120, multiple reimbursement consultant facilities 150, multiple payer facilities 160, but no pharmacy facility 140. Additionally, it should be recognized that additional facility types can be provided. For example a similar facility can be provided at the location of a shipper so that a shipper can receive shipping orders for medical treatments. Further, a similar facility can be provided at the location of a manufacturer of a medical treatment for receiving orders for medical treatments. Thus, many combinations of facilities are possible in accordance with the invention.

Further, it should be recognized that not all facilities 110, 120, 130, 140, 150 and/or 160 include each of a computer terminal, a telephone, a database, and a facsimile machine. For example, in some embodiments, patient facility 130 does not include facsimile machine 134.

Facilities 110, 120, 130, 140, 150 and/or 160 communicate with other facilities across network 170. For example, computer terminal 121 can communicate with computer terminal 111, preferably across the Internet via e-mail or by directly accessing database 113. Further, communication can occur by providing Internet pages from database 113, which are displayed at computer terminal 121, or any other computer terminal. Such Internet pages provide an interface for entering information into system 100. Alternative interfaces include form letters, interactive letters, data prompts or other interfaces for accepting information into system 100. Use of form letters, interactive letters, data prompts and other interfaces are described in more detail below. In general, such interfaces are provided from any facility and completed at any other facility. For example, an interactive letter may be provided from system facility 110 to provider facility 120 where a user completes the interactive letter and submits it to system facility 110.

It should be recognized that a number of communication combinations between facilities 110, 120, 130, 140, 150 and/or 160 can be supported according to the invention. In some embodiments, such communication involves providing an Internet page from database 113, which is displayed at computer terminal 131, receiving at computer terminal 111 data entered in fields of the Internet page at computer terminal 131, and the data being formatted and sent by computer terminal 111 or facsimile machine 114 to computer terminal 161 or facsimile machine 164. Of course, many other combinations are possible.

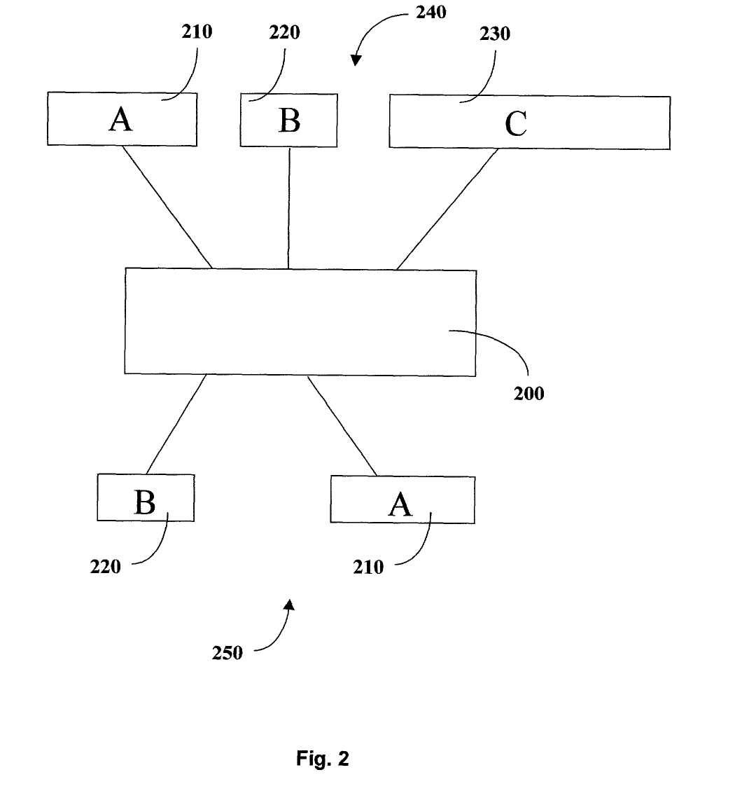

Referring to FIG. 2, in some embodiments, system 100 includes an interface 200 associated with databases 123, 133, 143, 153, and/or 163 for providing data compatible with database 113. While interface 200 may work similarly with any of databases 123, 133, 143, 153, and/or 163, its operation is described with respect to database 123 associated with provider facility 120. Database 123 comprises a number of records, each of which may include a group 240 of data fields 210, 220 and 230. Each of the fields 210, 220 and 230 represent discrete information maintained in database 123, such as a patient's name, the provider's address, the provider's number, a payer associated with the patient, etc. In accordance with one embodiment of the present invention, it may be preferable to communicate information from databases 123, 133, 143, 153 and/or 163 to system facility 110, where it is maintained in database 113. However, database 113 may include a group 250 of data fields 220 and 210 arranged differently than group 240 of database 123.

Interface 200 acts as a conversion program, selecting information from database 123 and transferring it to system facility 110, where it is stored as group 250 on database 113. In this case, interface 200 selects fields 210 and 220. Further, interface 200 arranges selected fields 210 and 220 so that they are compatible with database 113. Using this general process, interface 200 can automatically supply information from provider facility 120 to system facility 110.

As an example of one embodiment of the present invention, interface 200 is used to populate multiple information fields of a form letter displayed at computer terminal 121 and served from database 113. Two of the information fields as represented by group 250 may be provider address 210 and payer identification 220, both of which are associated with a patient's name which is stored in field 230 of database 123. A user of computer terminal 121 enters the patient's name into the form letter and selects an auto-populate option provided as part of the form letter. Interface 200 selects provider address 210 and payer identification 220 from database 123 which correspond to the entered patient's name. The selected provider address 210 and payer identification 230 are then automatically entered in the form letter in the proper information fields illustrated as group 250. If the user is satisfied with the data automatically entered in the fields, the user transmits the populated form letter to system facility 110 where it is stored on database 113.

In some embodiments, the fields in database 113 are used to create a static map for correlating fields in database 113 with fields available from database 123. In operation, interface 200 is provided with the required fields, such as the fields of a form letter. Interface 200 then uses the map to identify data in database 123 for populating the required fields. Interface 200 retrieves the identified information and provides it to the user by, for example, populating fields of the form letter.

In other embodiments, interface 200 iteratively learns database 123 to build a map for correlating fields required by database 113 to fields available from database 123. In such an embodiment, a user of computer terminal 121 enters information prompted by system facility 110. Prompting can occur by way of displaying a form letter with vacant fields at computer terminal 121. As the user enters information in a required field, interface 200 compares the data required by the letter field with data entered by the user. Interface 200 then compares data entered by the user with data in database 123. Where a match is found, the data field in database 123 where the data was found is mapped to the field of the letter. Thus, the next time a similar letter is updated by the user, interface 200 will know which fields of database 123 correspond to the fields of the letter.

At times, the data entered by the user may not uniquely identify a field in database 123. Thus, the same process of comparing and mapping may need to pass through several iterations before a complete map correlating database 123 with a given letter is provided.

In yet other embodiments, interface 200 is not included. Where interface 200 is not included, information can either be entered by a user and submitted to system facility 110 or provided from database 113. In some embodiments, database 113 may be configured to store particular patient information. Thus, the first time a user accesses the system he will need to provide all information related to a particular patient, which is then stored on database 113. On subsequent accesses, all that is required is to enter the patient's identification and the system will automatically populate fields using information maintained on database 113. If populated information is erroneous, a user can override the information by overwriting a populated field. When a user overrides a populated field, system facility 110 assumes a change in the information and accordingly updates database 113.

It should be recognized that automatic population using any of the described mechanisms is not limited to communication between provider facility 120 and system 110, and can be used for communications between system facility 110 and any other facility. Alternatively, such automatic processes can be provided between any of the facilities in system 100.

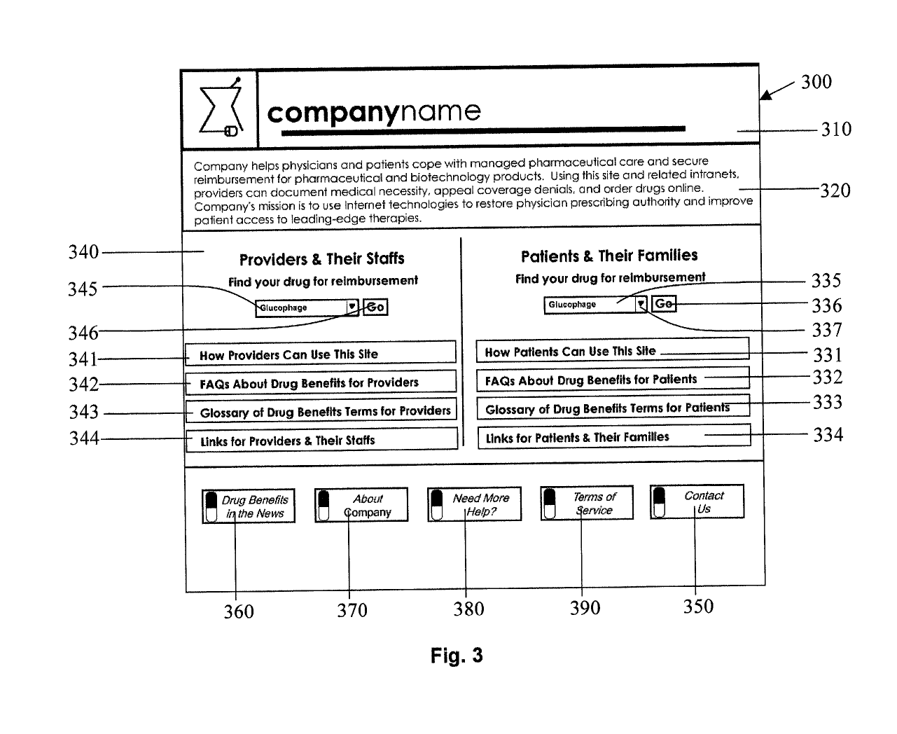

In accordance with one embodiment of the present invention, access to system 100 is provided through an Internet page 300 illustrated in FIG. 3. Referring to FIG. 3, Internet page 300 includes a name 310 of the company providing system 100, a statement 320 of the company's purpose, a section 330 for patients and their families, and a section 340 for providers and their staffs. Further, Internet page 300 includes: a hyperlink 360 for accessing treatment benefits in the news, a hyperlink 370 for accessing additional information related to the company providing system 100, a hyperlink 380 for accessing additional system help, a hyperlink 390 for accessing any terms for using system 100, and a hyperlink 350 for initiating communication with the company providing system 100 and/or system facility 110. In some embodiments, the terms for using the system include contractually binding terms and/or liability limiting terms.

Hyperlink 380 provides access to information related to system 100. For example, the information can guide a user on how to enroll a patient, care provider, pharmacy, treatment manufacturer, treatment distributor and/or payer. In some embodiments, hyperlink 380 can access an interface requesting provider specific information and/or assistance. In some embodiments, this assistance includes direct communication with representatives of the system operator. This information can be communicated to a supplier and/or manufacture of a treatment. The supplier or manufacturer can send a representative to provide a password and to teach the provider how to use system 100. After receiving the password, the provider then can use system 100 to obtain approvals and/or reimbursements from payers.

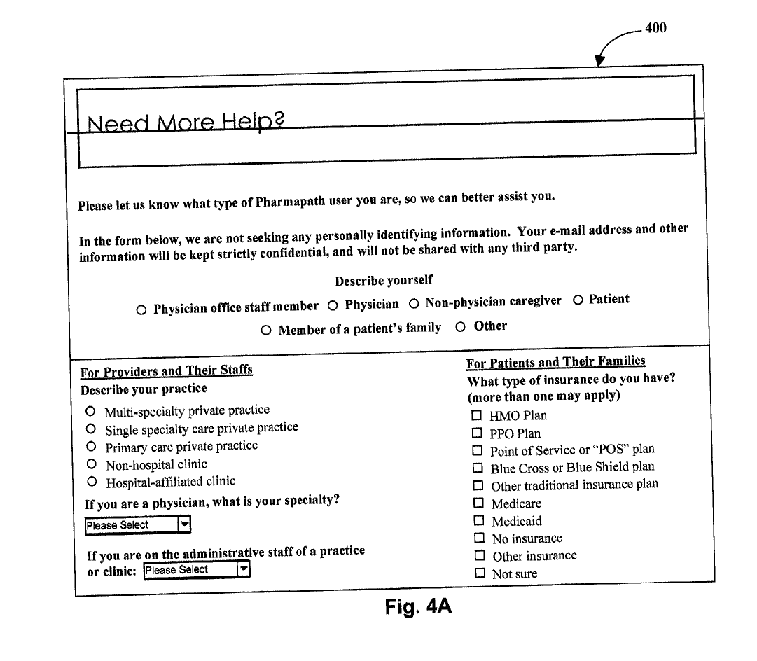

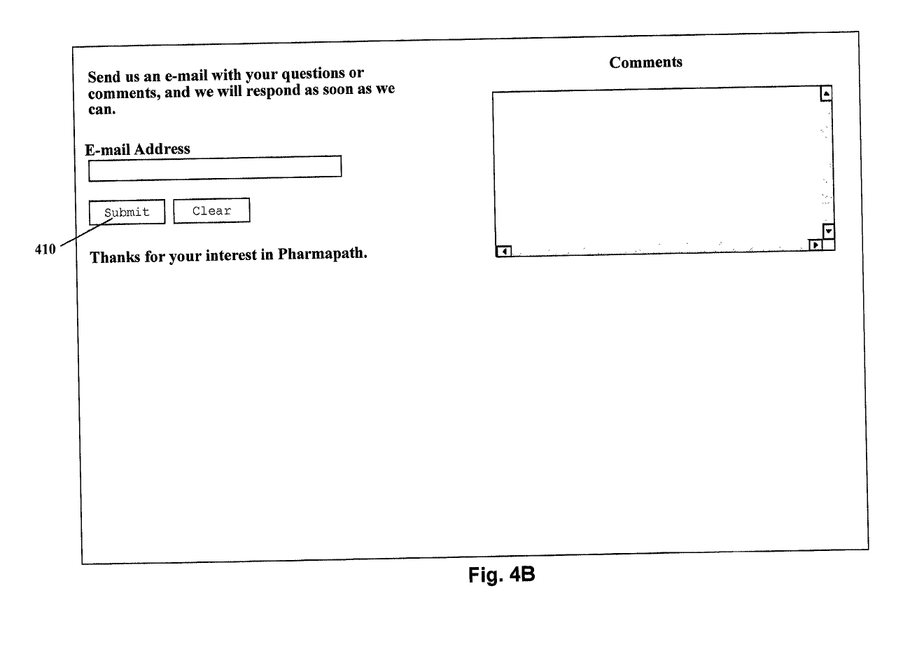

As illustrated in FIGS. 4A-4B, Internet page 400 is particularly suited for gathering provider information. A user populates various fields of Internet page 400 and selects a submit button 410. After submit button 410 is selected, the populated information is transferred to system facility 110. The information then can be used to assure a user is enrolled to use system 100.

Referring again to FIG. 3, section 340 includes a hyperlink 341 for accessing instructions geared toward professionals on how to use system 100, a hyperlink 342 for accessing frequently asked questions regarding drug benefits for providers, a hyperlink 343 for accessing a glossary of drug benefit terms for providers, a hyperlink 344 for accessing additional information specific to providers and their staffs, a selector 345 for entering a specific treatment, and a button 346 for initiating system operation.

In section 330, there is a hyperlink 331 for accessing instructions geared toward laymen on how to use system 100, a hyperlink 332 for accessing frequently asked questions regarding drug benefits for patients, a hyperlink 333 for accessing a glossary of drug benefit terms for patients, a hyperlink 334 for accessing additional information specific to patients and their families, a selector 335 for entering a specific treatment, and a button 336 for initiating system operation. As used in this document, laymen include patients, consumers, or any other non-health care professional.

In accordance with one embodiment of the present invention, section 340 is similar to section 330, however, the discussion and terminology provided in section 340 is suited to a provider as opposed to the discussion and terminology in section 330, which is suited to a layman. This dual discussion level provides audience specific information, making system 100 accessible to a broad range of users. Additionally, it should be recognized that more than two-levels of discussion and terminology may be used according to the present invention when disparity between users warrants such treatment. For example, there may be instances where discussion levels appropriate to a physician, a physician's staff, a patient, and a pharmacist are each provided. Further, one skilled in the art would recognize that sections in addition to sections 330 and 340 could be provided for other groups, such as pharmacists. Alternatively, a single section embodying both sections 330 and 340 could be used along with a selector for identifying a level of discussion to be provided.

Examples of the dual discussion levels are noted in the way a medication or other treatment is described. For example, a description of the medication GLUCOPHAGE™ provided by accessing section 340 is different from a corresponding definition accessed through section 330. Specifically, in section 330, for a layman's benefit, the medication is described as “a drug that treats non-insulin dependent diabetes.” In contrast, in section 340, the medication is described as “an oral anti-diabetic medication used to treat Type 2 diabetes.”

Also, the invention can provide access to different information based on the level of discussion provided. In one embodiment, a different set of Internet pages are accessible through section 340 than through section 330. For example, for the medication GLUCOPHAGE™, section 330 provides a hyperlink to information describing Type 2 diabetes. In contrast, a physician does not need a description of Type 2 diabetes and thus, a hyperlink to information about Type 2 diabetes is not provided when accessing system 100 through section 340.

In one embodiment of the present invention, operation of system 100 through section 330 is similar to operation through section 340. Accordingly, operation of system 100 is only described in relation to section 330. To operate system 100 from section 330, a user selects a treatment by entering the treatment into selector 335 via some means of communicating with the user terminal. Entering the treatment can be accomplished either by keying the name of the treatment into selector 335, by using a pull down bar 337 next to selector 335, or by any other suitable selection process. Once the particular treatment is entered in selector 335, button 336 is selected, for example by using a mouse (not shown), to begin operation of the system. Alternatively, operation can be initiated by pressing the return key (not shown) on a keyboard (also not shown). Once operation is initiated, an Internet page corresponding to the selected treatment is displayed at the user's terminal. The Internet page displayed depends upon a level of service either provided by system facility 110 or accessible to the user.

In accordance with one embodiment of the present invention, there are three levels of service provided: Basic, Expanded, and Reimbursement Desktop. Each level of service is described with reference to different figures. Basic is described in relation to FIGS. 3 and 5-8, Expanded is described in relation to FIGS. 3 and 9-11, and Reimbursement Desktop is described in relation to FIGS. 3 and 12-22.

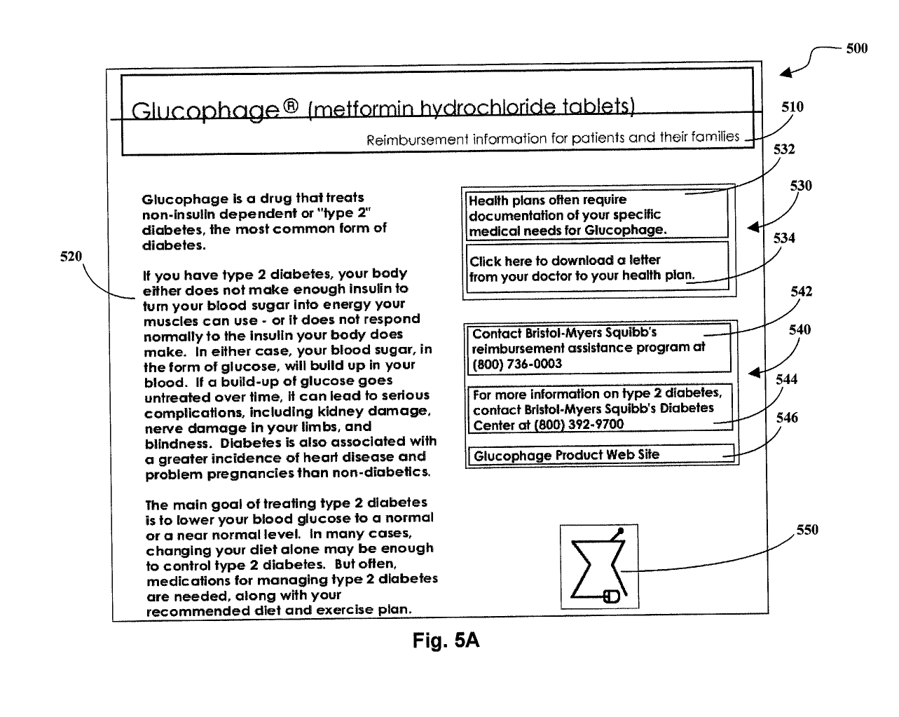

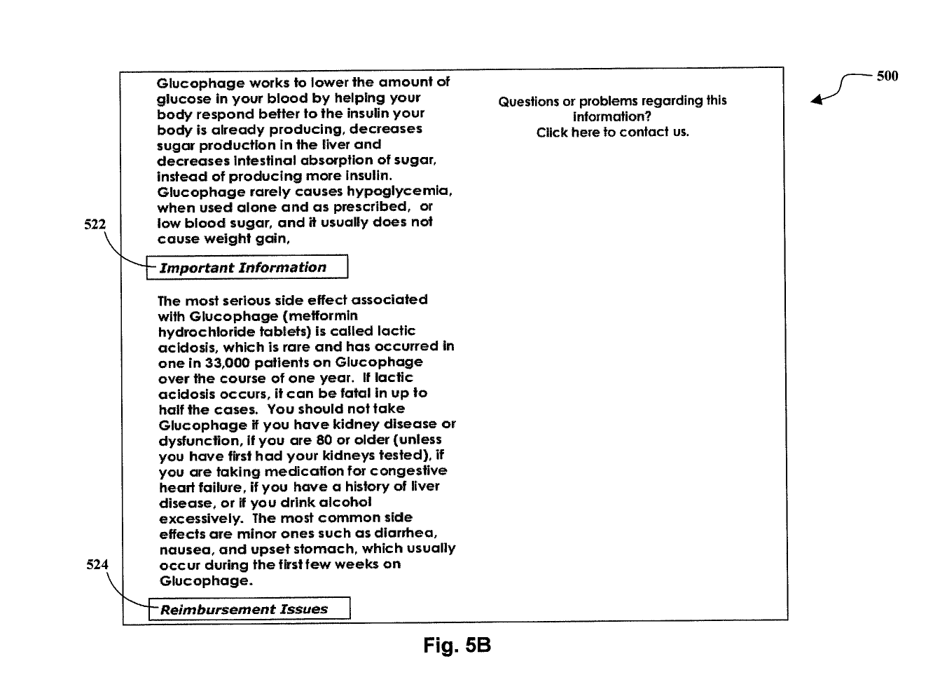

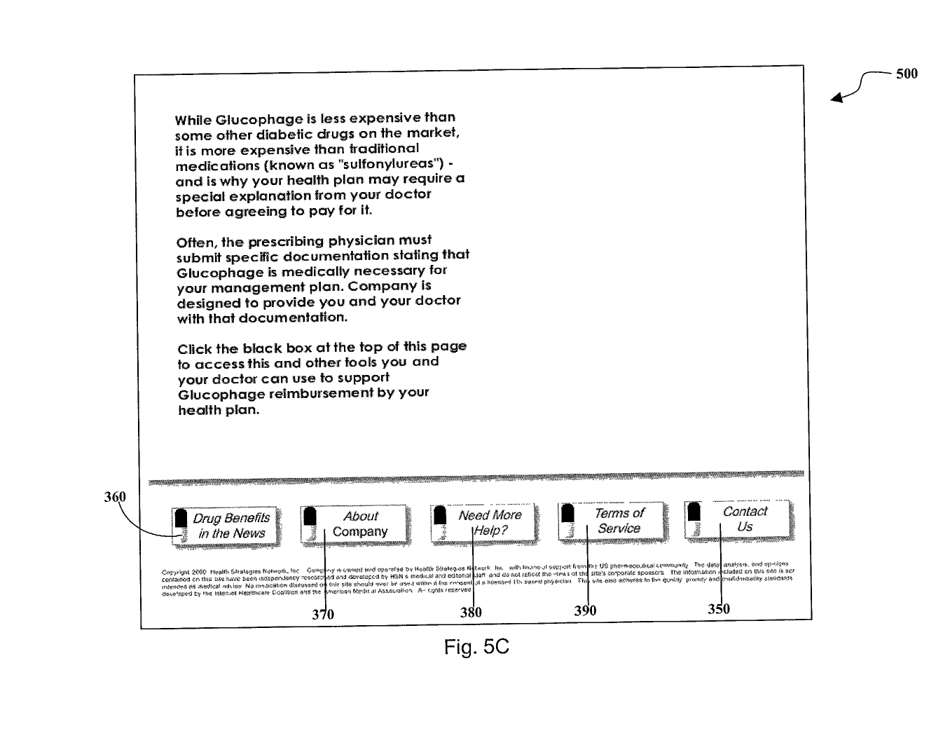

Referring to FIGS. 5A-5C, Internet page 500 shows the Basic level of service for the medication GLUCOPHAGE™. Internet page 500 includes a selected treatment 510 which corresponds to the treatment entered in selector 335 on Internet page 300. In addition, Internet page 500 includes a description 520, which describes selected treatment 510 with the description being tailored to a specific audience as described in relation to FIG. 3, a section 530 containing hyperlinks to approval information, a section 540 containing hyperlinks to additional assistance information and additional information about selected treatment 510, and a hyperlink 550 for initiating communication to resolve any questions or problems. In an embodiment of the present invention, the communication initiated is an e-mail to the provider of system 100. Description 520 includes a discussion 522 of important side effects and reimbursement issues 524 associated with selected treatment 510.

Section 530 includes hyperlinks for accessing general approval, diagnosis and reimbursement information for selected treatment 510. Further, general purpose LMNs and pre-authorization letters are provided by selecting a hyperlink 534. Examples of such a general purpose letters are described below with reference to hyperlink 534. The forms are presented in a user-friendly customizable manner adapted for printing, and submission to a payer. Further, by selecting a hyperlink 532, a user is given access to general procedures and guidelines for submitting an LMN, a pre-authorization form, or other approval or reimbursement form to a payer. In some embodiments, hyperlink 532 is not an active link, but rather an information field which includes the general procedures and guidelines.

Section 540 includes information and hyperlinks for contacting treatment suppliers and manufactures for approval and reimbursement support or any other suitable information. In some cases, suppliers and/or manufacturers of a particular treatment maintain, or outsource systems to support procuring approval and reimbursement for a particular treatment. Such systems may include representatives experienced with a number of payers for the particular treatment. Thus, section 540 includes a telephone number for contacting a supplier's and/or manufacturer's reimbursement assistance program in information field 542. Alternatively, information field 542 can include a hyperlink (not shown) to an Internet page providing information on using a supplier's and/or manufacturer's reimbursement assistance program. Yet another embodiment includes a hyperlink for initiating an e-mail regarding a reimbursement assistance program.

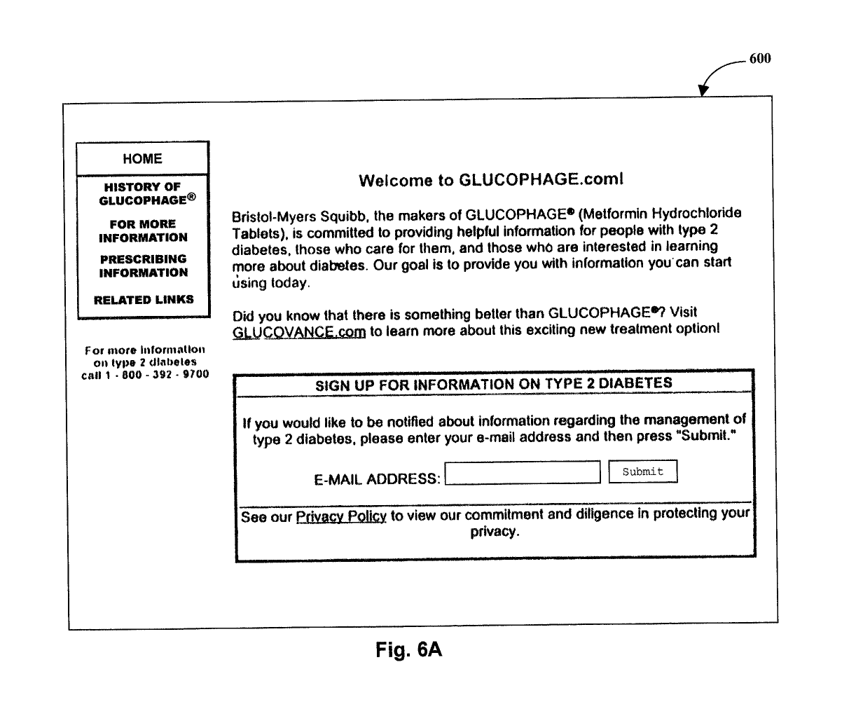

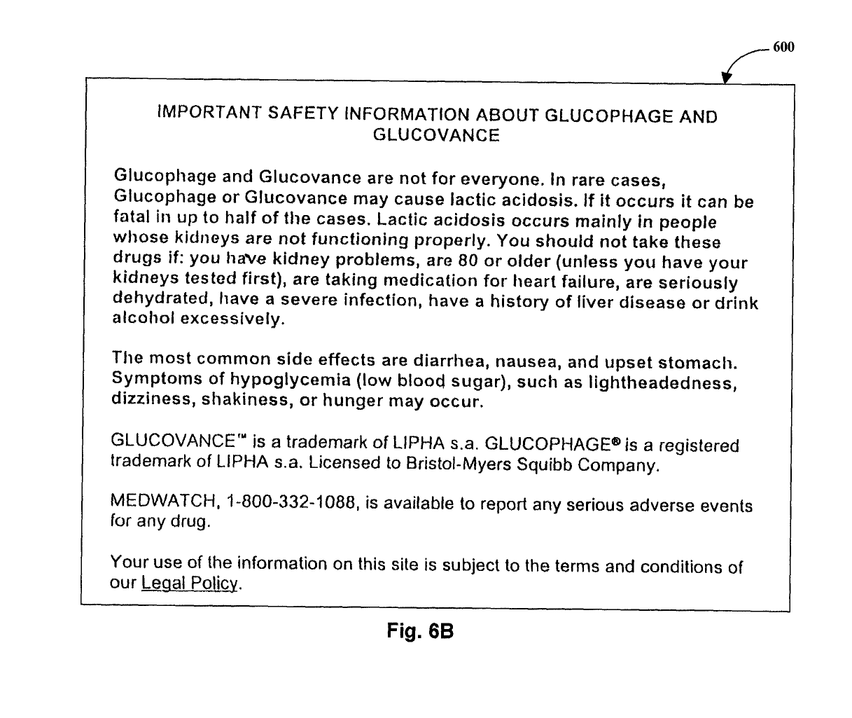

By selecting a hyperlink 546 a user accesses commercial and informational data about a particular treatment. In some embodiments, the data is provided by linking to an Internet page maintained by a treatment supplier and/or manufacturer. In other embodiments, such commercial and/or informational data related to selected treatment 510 can be provided by a manufacturer, a government agency or any other source of information. An example of such a commercial and/or informational Internet page 600 is illustrated in FIGS. 6A-6B which are self explanatory. A hyperlink 544 provides access to information about a particular disease associated with selected treatment 510. In some embodiments, section 540 includes access to and/or contact information about patient advocacy, disease-oriented support groups, and other information relevant to the treatment. Further, a list of providers offering a particular treatment can be provided.

When the user selects hyperlink 534, an approval letter is provided at the user's computer terminal. Alternatively, such a letter is provided to the user by regular physical mail. It should be recognized by one of ordinary skill in the art that the approval letter could be provided to the user by any number of electronic and/or physical means, such as, by facsimile.

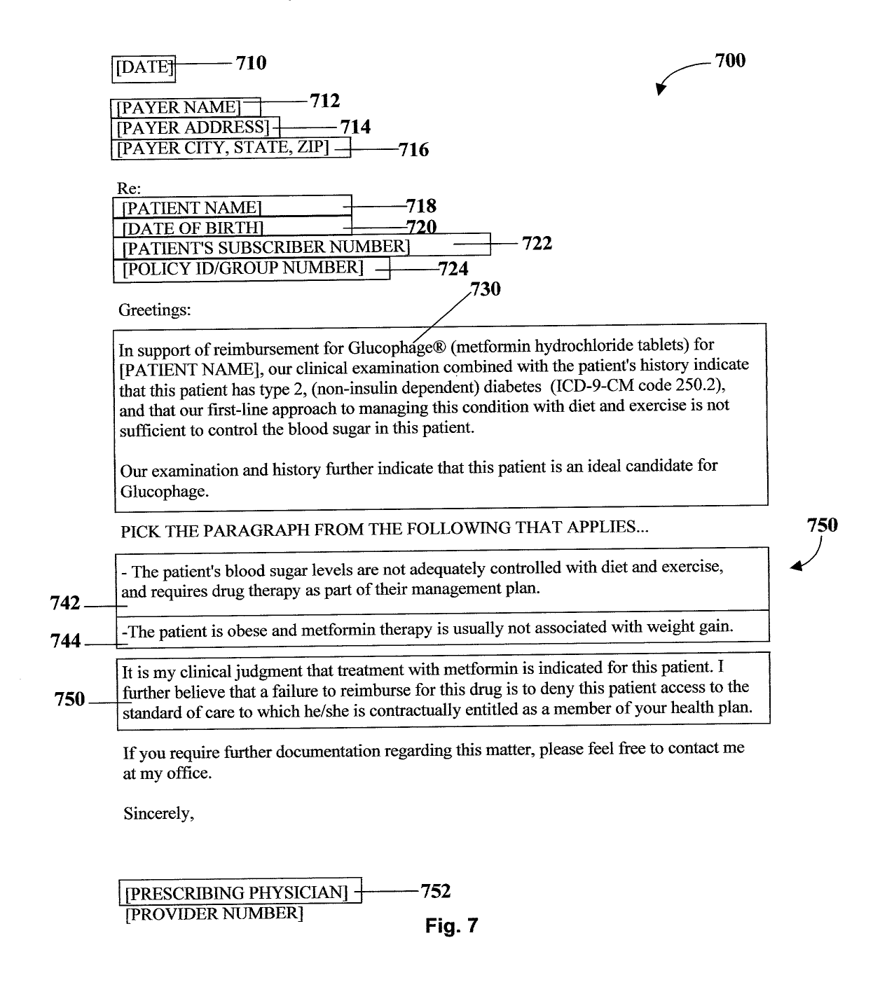

In one embodiment of the present invention, the approval letter is a form letter 700 illustrated in FIG. 7. Referring to FIG. 7, form letter 700 includes fields 710, 712, 714 and 716 for entering the date and the payer's contact information, fields 718, 720, 722 and 724 for entering an patient's identification information, a general salutation 730 specific to selected treatment 510, a section 740 including various indicia (742 and 744) for selected treatment 510, and a final remarks section 750 including provider contact information 752.

In some embodiments, section 740 includes a multi-tiered indicia selection. For example, some treatments require highly specific diagnosis before approval will be granted by a payer. Thus, section 740 can include a first indicia indicating a general diagnosis and a group of second indicia related to the first indicia. Further, section 740 can include a plurality of first indicia and a plurality of second indicia associated with particular first indicia. It should be noted that any level of diagnosis specificity can be supported according to the present invention.

As an example of a multi-tiered diagnosis, the medication LUPRON™ generally requires the following two-level diagnosis for approval by a payer. First, the patient must either have endometriosis or fibroid tumors. If the patient has endometriosis, one of the following more specific diagnosis also should be included in the letter: (1) the patient has experienced moderate to severe symptoms over a sufficient duration of time to classify the condition as chronic, (2) the patient's symptoms have not responded to previous treatment with estrogen-suppressant therapy, and/or (3) the patient is at special risk of medical complications associated with non-responsive endometriosis, which may necessitate surgical interventions if ineffectively addressed. Alternatively, if the general diagnosis is fibroid tumors, one of the following more specific diagnosis also should be included in the letter: (1) the patient has experienced moderate to severe symptoms over a sufficient duration of time to classify the condition as chronic, (2) the patient's symptoms have not responded to previous treatment with estrogen-suppressant therapy, and/or (3) the patient's condition is likely to worsen, if ineffectively addressed, which would necessitate surgical intervention. Accordingly, a user desiring to get approval to use or to get approval for a patient to use LUPRON™ would select a proper combination of first and second indicia to support their request.

To use form letter 700, data for fields 710, 712, 714, 716, 718, 720, 722 and 724 is entered at the user's terminal. In addition, one or both of the indicia (742 and/or 744) is/are selected by a provider or other competent person to be part of the final letter and any unselected indicia (742 or 744) is deleted from the final letter. Thus, the completed letter includes contact information, patient identification information, and diagnosis information generally needed to support approval from a payer.

In some embodiments, where a user is sufficiently identified to system 100, any or all of fields 710, 712, 714, 716, 718, 720, 722, 724 and/or 752 can be automatically entered by system 100 and form letter 700 presented to a user in a partially completed state. Thus, where a user is sufficiently identified to system 100, the user will be presented with form letter 700 requiring only a modification to section 740. In yet other embodiments, a user may provide a diagnosis code to system 100 and form letter 700 is presented to the user in a completed state. Such automatic population of letter 700 is accomplished as previously described in relation to interface 200. Alternatively, letter 700 can be populated from a database local to the user as previously described.

Upon completing form letter 700, the user electronically submits the completed letter to system 100 and prints a copy of the completed letter. The printed copy is signed and submitted to an appropriate payer and/or other recipients. Recipients of the letter can include any or all of the payer, the provider of system 100, a representative of the manufacturer and/or supplier of selected treatment 510, or any other necessary party. In another embodiment of the present invention, system 100 submits an electronic copy of the letter to a selected payer in parallel to the printed letter. The electronically submitted copy is provided with an indication that a signed copy is forthcoming. Such electronic submission allows approval processes to begin prior to receipt of the signed, printed version of the letter. In yet other embodiments of the present invention, the completed letter includes an electronic signature, thus overcoming the need to provide a signed physical copy of the letter.

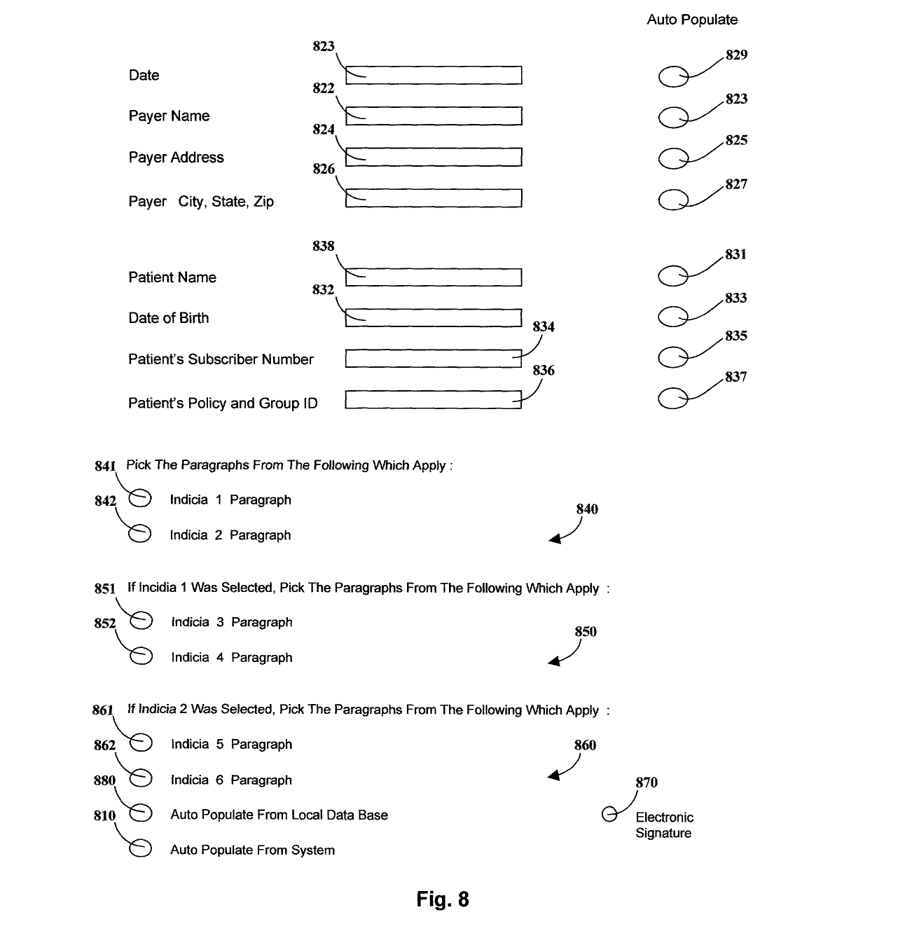

In one embodiment of the present invention, an interactive letter 800, illustrated in FIG. 8, is used in place of form letter 700. Referring to FIG. 8, interactive letter 800 includes a number of fields for accepting information related to the letter to be created. Interactive letter 800 includes radio button 810, the selection of which causes system 100 to populate known fields from data maintained in system 100. Interactive letter 800 also includes section 820 having entry fields 828, 822, 824 and 826 and buttons 821, 823, 825 and 827 related to populating payer related information, a section 830 having entry fields 838, 832, 834 and 836 and buttons 831, 833, 835 and 837 related to populating patient related information, a section 840 having buttons 841 and 842 for selecting first level diagnosis indicia, and sections 850 and 860 having buttons 851, 852 and 861, 862 respectively for selecting second level diagnosis indicia. Further, interactive letter 800 may include a button 870 for inserting an electronic signature, and a button 880, the selection of which causes system 100 to populate known fields from data located at a database local to the user.

To create a letter using interactive letter 800, the user either enters the appropriate information or selects an auto populate option. For example, if system 100 has a significant quantity of information about the patient, payer and/or provider, the user may select button 810 causing system 100 to populate as many fields as system 100 has corresponding data. Either alternatively to or in combination with button 810, the user may select button 880 causing all unpopulated fields for which data is available local to the user's terminal to be accessed to fill various fields. Any fields which remain unpopulated can be keyed in by the user in fields 828, 822, 824, 826, 838, 832, 834 and/or 836. Alternatively, the user can select any of buttons 821, 823, 825, 827, 831, 833, 835 and/or 837 to cause only the associated field to populate from either data maintained on system 100 or local to the user.

Once data for sections 820 and 830 are provided, an appropriate diagnosis is selected. Interactive letter 800 provides an example of a two-tiered diagnosis. In selecting the appropriate diagnosis, the user selects either or both buttons 841 and/or 842. If button 841 is selected, the user then selects either or both buttons 851 and/or 852. Similarly, if button 842 is selected, the user then selects either or both buttons 861 and/or 862.

It should be recognized that an interactive letter can be configured to prompt for additional information based on prior entered information. Thus, the interactive letter can be presented as a series of deterministic questions. For example, in some embodiments, where a two-tiered diagnosis is needed, a user is prompted for a general diagnosis and subsequently prompted for a specific diagnosis related to the general diagnosis. In other embodiments, diagnosis sections 840, 850 and 860 are not shown until after a particular treatment is selected. After a particular treatment is selected, sections 840, 850 and 860 including indicia specific to the selected treatment is provided.

In cases where it is appropriate, an electronic signature is included with the created letter by selecting button 870. After all of the appropriate fields are populated and buttons selected, an approval letter is created corresponding to the provided information. The approval letter is handled as previously described with relation to letter 700.

Any of the methods previously described can be used to create LMNs, pre-authorization letters, response letters to payer denials, and/or any other letter necessary to the approval and reimbursement systems. Thus, it should be recognized that any number of letter formats may be used according to the present invention. Further, it should be recognized that any combination of the letter fields may be populated by any combination of data from the user, system 100, and a database local to the user. For example, a particular user may desire to put different information in a particular field than that known by system 100, accordingly, the user may either indicate that system 100 is to leave the field blank or the user may override information automatically entered by system 100.

Other embodiments of the present invention provide an Expanded level of service. The Expanded level of service may include everything in the Basic level plus an LMN, pre-authorization forms and procedures, benefit compliance forms and procedures, and appeal forms and procedures, which are consistent with each payer's specific requirements. Further, payer phone and facsimile numbers as well as, in some embodiments, an e-mail address related to approval requests, pre-authorization requests, benefit compliance and denial appeals may be provided. System 100 is capable of accepting a payer specific form electronically or otherwise from a user and communicating the received form by facsimile, e-mail or regular mail directly to the specific payer. Information on system 100 is continually updated to include all changes in payer specific information.

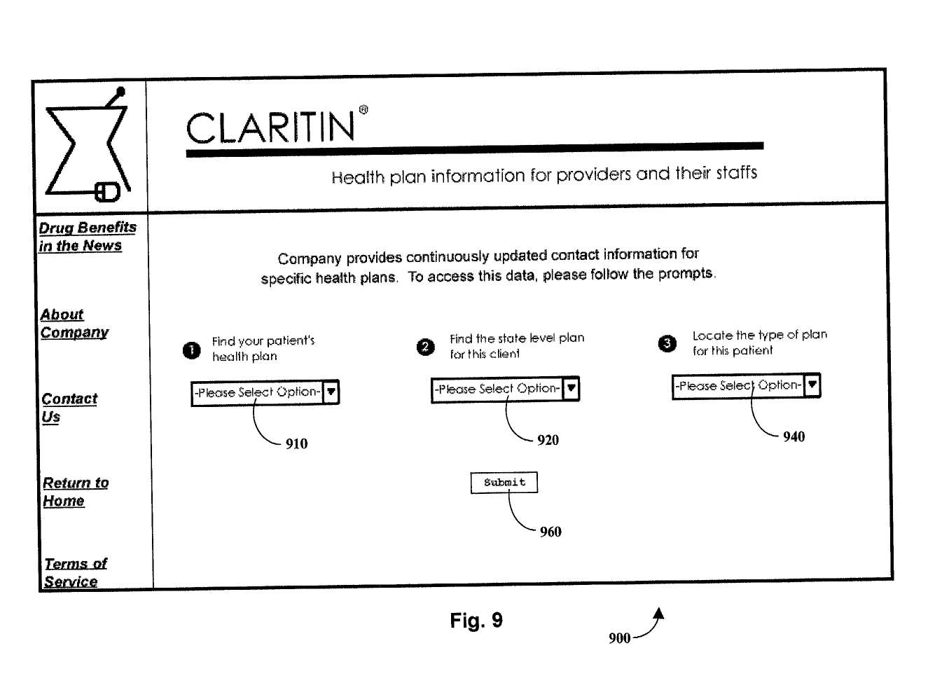

When the Expanded level of service is available, a user is prompted for payer specific information. Thus, in an embodiment, when hyperlink 534 is selected, an Internet page 900, as illustrated in FIG. 9, is provided at the user's terminal. Referring to FIG. 9, Internet page 900 would be accessed where an expanded service level was available and the medication CLARITIN™ was under consideration. Internet page 900 includes a field 910 for indicating a particular payer. Fields 920 and 940 are used to uniquely identify a particular payer plan. Field 920 allows for entry of the geographic location of the payer and field 940 allows for entry of the particular plan that the patient is enrolled in. After populating fields 910, 920 and 940, a particular payer is uniquely identified. After the payer is uniquely identified, a user selects a submit button 960.

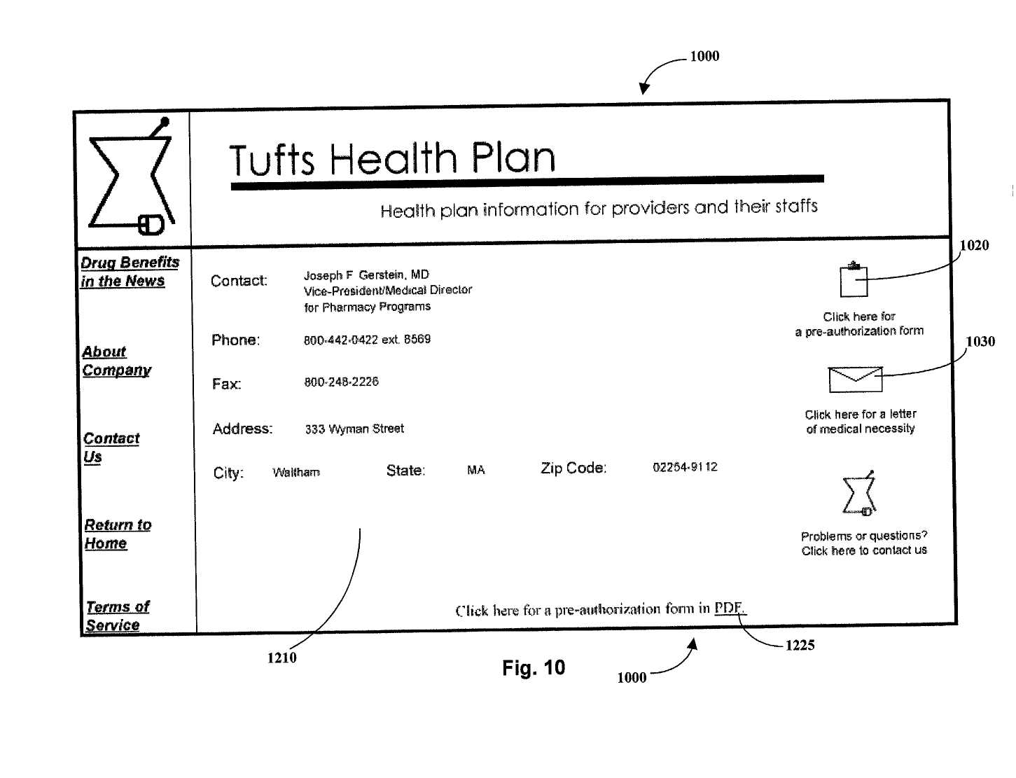

Upon selecting submit button 960, Internet page 1000, illustrated in FIG. 10, appears at the user's terminal. Referring to FIG. 10, an embodiment of Internet page 1000 includes up to date contact information 1010 for the particular payer, in this case Tufts Health Plan of Massachusetts. In addition to contact information 1010, a hyperlink 1020 for accessing a pre-authorization form specific to the particular health plan is provided. Further, a hyperlink 1025 is provided for accessing a similar pre-authorization letter in an alternative format, in this case PDF. Also, a LMN is accessible by selecting a hyperlink 1030. In some embodiments, a user may be presented with additional specific approval requirements of the specific payer for a selected treatment.

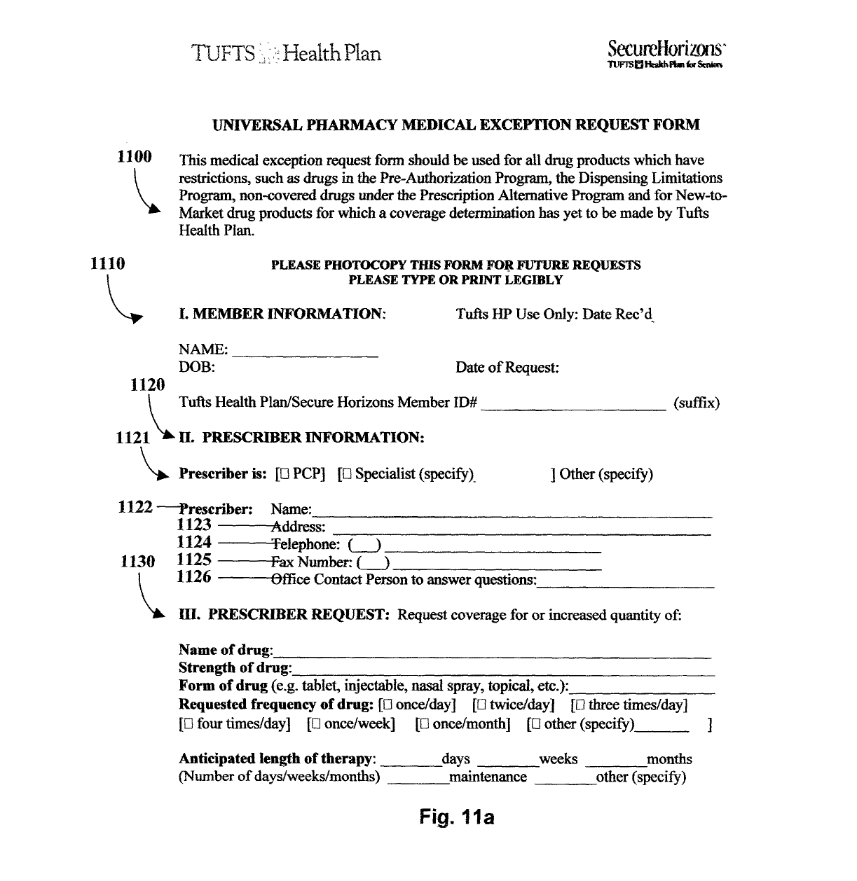

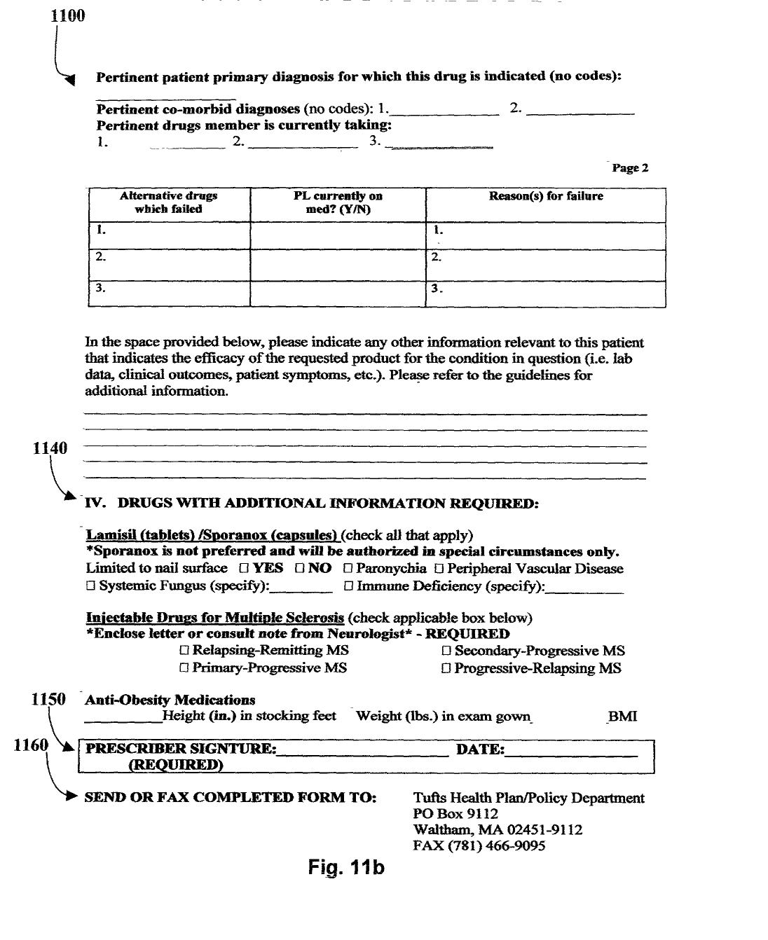

Upon selecting hyperlink 1020, a pre-authorization form 1100, for example as illustrated in FIGS. 11A-11B, appears at the user's terminal. Referring now to FIG. 11, pre-authorization letter 1100 includes fields and sub-fields that may be required by the selected payer. The fields include member information fields 1110, prescriber information fields 1120, prescriber request fields 1130, fields requesting additional information for a specif drug 1140, a signature field 1150 and contact information 1160. In some embodiments, upon accessing pre-authorization letter 1100, many of the sub-fields may be automatically populated by system 100. For example, where prescriber information is known to system 100, sub-fields within prescriber information fields 1120 are automatically populated. The sub-fields include a prescriber type 1121, a prescriber name 1122, a prescriber address 1123, a prescriber telephone number 1124, a prescriber fax number 1125 and/or a prescriber contact person 1126. Automatic population can be provided as described in relation with FIGS. 7 and 8 above.

Similarly, other fields and sub-fields of letter 1100 can be automatically populated. Where the automatic population results in erroneous data in any of the fields or sub-fields, the user can simply re-enter the correct information over the automatically populated information. Upon completing pre-authorization letter 1100, the user e-mails it to system facility 110 and prints a copy for signature. The signed copy is sent directly to the specific payer where a signature is often required for approval. System facility 110 forwards the pre-authorization letter 1100 to the payer, drug company or other party necessary for gaining approval. In an embodiment, system facility 110 communicates pre-authorization letter 1100 to the payer by facsimile machine. In other embodiments, pre-authorization letter 1100 is communicated by e-mail and in yet other embodiments, letter 1100 is electronically updated in the payer's database 163. By providing electronic transmission of letter 1100 to the payer, the payer is enabled to begin the pre-authorization process more quickly than if the payer was to wait for a signed copy to be otherwise delivered. In the case where a physical signature is required, the pre-authorization can be completed before the signature arrives, and the results of the pre-authorization communicated upon arrival of the signed copy. In some embodiments, electronic signatures are supported. In these embodiments, letter 1100 can include an electronic signature which overcomes the need for sending a signed copy of letter 1100 to the payer.

Upon selecting hyperlink 1030, a payer (TUFTS) and treatment (CLARITIN™) LMN is provided. The letter is used similarly to letter 700 and/or letter 800 described in relation to FIGS. 7 and 8, respectively. As provided for in the discussion of FIGS. 7 and 8, various fields can be automatically populated. Thus, in some embodiments, the user may have previously stored their payer information on system 100 related to a particular patient, in which case the user merely needs to identify the patient to system 100 to have all other fields automatically populated.

In yet a higher level of service called the Reimbursement Desktop, features in addition to those described in relation to the Basic and Expanded service may be provided. The additional features may include customized, automated support for a treatment supplier's and/or manufacturer's current reimbursement support programs. System 100 includes support for obtaining approval from payers for a specified treatment by accessing a manufacturer's and/or supplier's support system and representatives at facility 150. In one embodiment of the present invention, the support for each different supplier and/or manufacturer may be customized. For example, a different appearance may be used so that a user knows the support is provided by a particular manufacturer or supplier providing the support. Furthermore, the support may be customized to provide features specific to a particular manufacturer, supplier, and/or treatment.

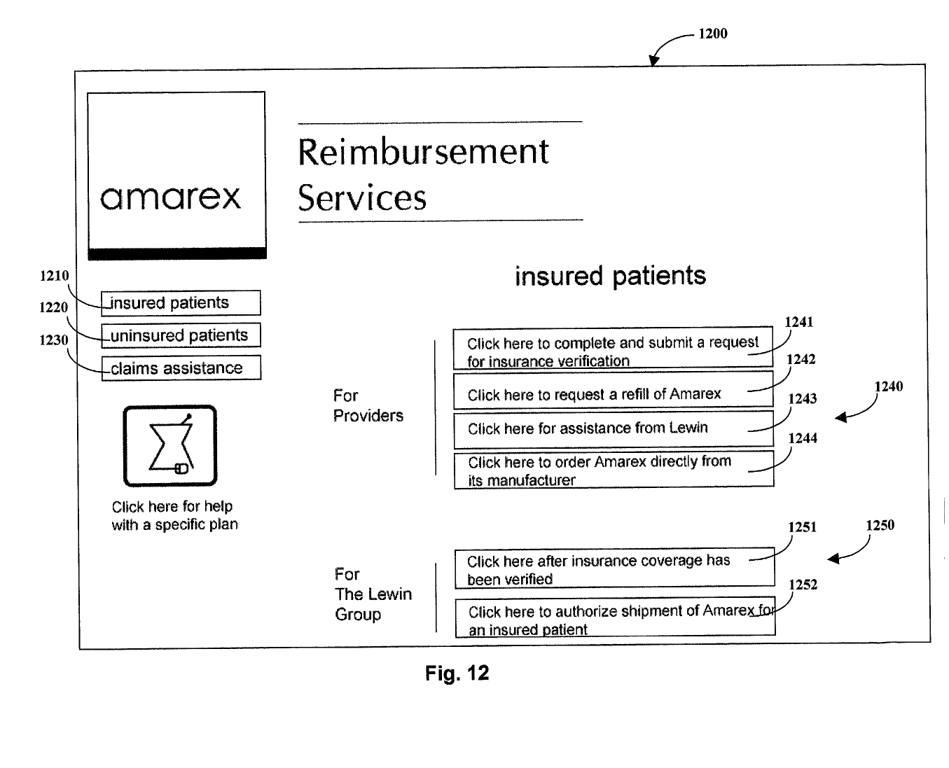

In some embodiments, where the Reimbursement Desktop is available, it may be accessed by selecting hyperlink 534. In other embodiments, another hyperlink (not shown) in addition to hyperlink 534 is provided which allows access to the Reimbursement Desktop for a selected treatment 510. An example of a Reimbursement Desktop 1200 specific to the treatment AMAREX is illustrated in FIG. 12. Reimbursement Desktop 1200 includes a hyperlink 1210 for accessing reimbursement help regarding insured patients, a hyperlink 1220 for accessing reimbursement help for uninsured patients, and a hyperlink 1230 for accessing claims assistance.

By selecting hyperlink 1210, a user is presented with Reimbursement Desktop 1200 for insured patients (the same Reimbursement Desktop illustrated in FIG. 12). Reimbursement Desktop 1200 includes section 1240 for providers and section 1250 for reimbursement consultants. Section 1240 includes a hyperlink 1241 for access to a page to complete and submit a request for insurance verification, a hyperlink 1242 for access to a page to request a refill of the treatment, in this case AMAREX, a hyperlink 1243 to request assistance from a reimbursement consultant, and a hyperlink 1244 to order a treatment directly from a supplier, manufacturer, or other designated source, such as a pharmacy. Section 1250 includes a button 1251, which if selected, indicates that insurance coverage has been verified by a reimbursement consultant, and a button 1252, which if selected, indicates approval to ship an ordered treatment to an insured patient.

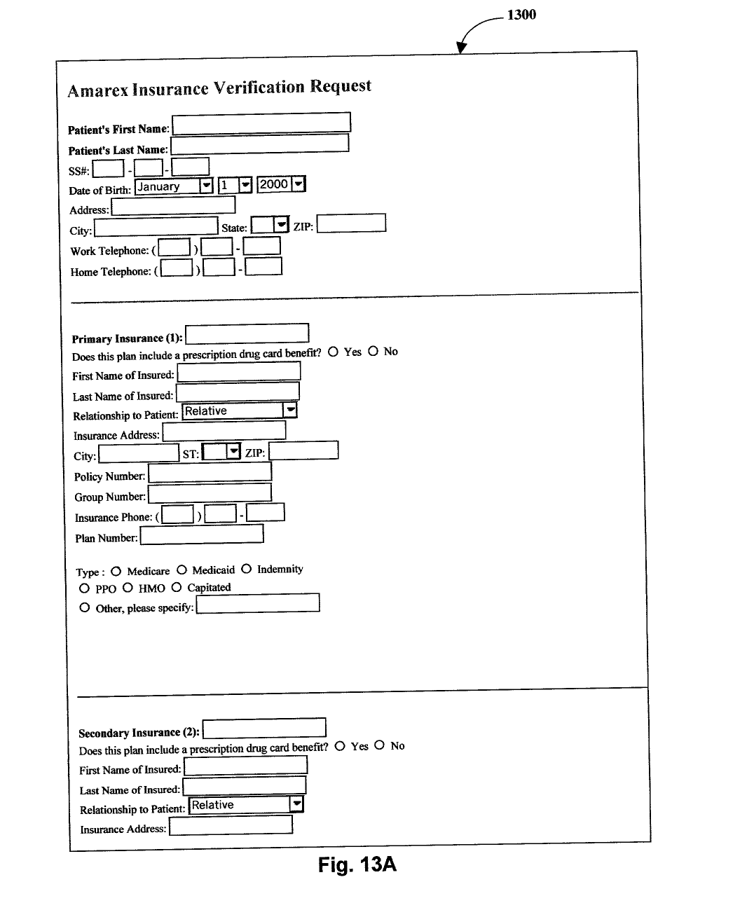

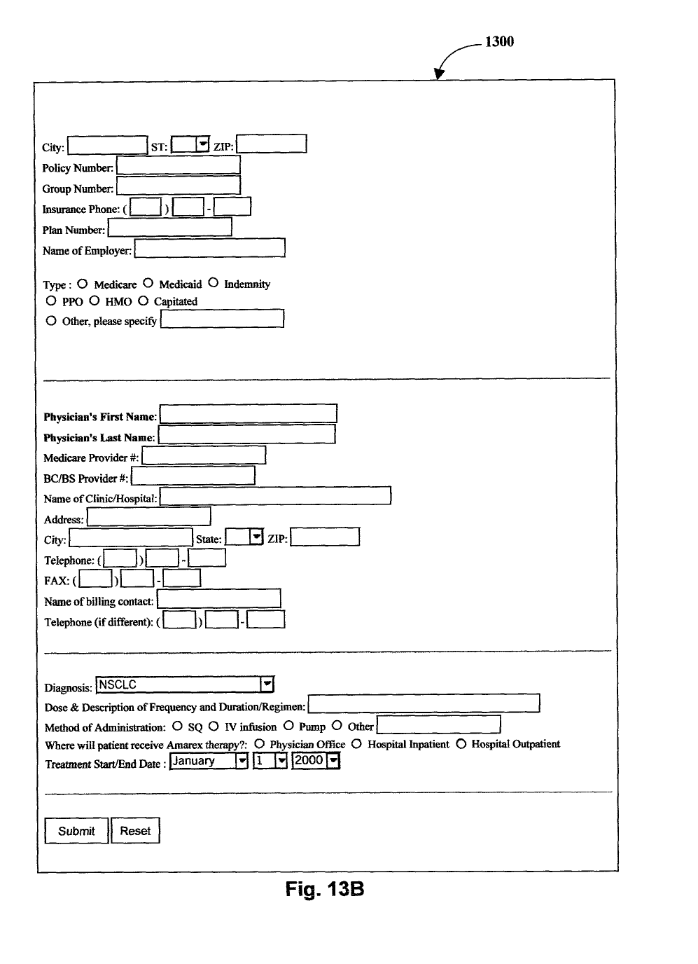

Reimbursement desktop 1200 is designed to provide interactive communication between a reimbursement consultant and a user. In operation, a user selects hyperlink 1241 and submits information required to verify insurance. The information entered is provided to a reimbursement consultant who then verifies that insurance coverage exists. In some embodiments, information may be entered using a form 1300 as illustrated in FIGS. 13A-13B. Use of form 1300 is self explanatory. Further, form 1300 can be automatically populated as described in relation to FIGS. 7 and 8.

The information is provided via form 1300 to the reimbursement consultant by any communication mechanism, such as e-mail, or the like, or by automatically updating the Reimbursement Desktop at the reimbursement consultant's location. In addition, the information is communicated to system facility 110. Thus, information from the form can be communicated through LMNs, pre-authorization letters and other materials provided to the reimbursement consultant from system facility 110, system facility 110 providing the aforementioned based on information provided via form 1300.

The reimbursement consultant then verifies insurance coverage. Verifying insurance coverage can include, among other things, obtaining payer pre-authorization for treatment reimbursement, communicating with payers and/or providers regarding coverage decisions, submitting appeals in response to coverage denials, among other processes. The reimbursement consultant accesses system 100 to achieve the desired approval for the user. Alternatively, all required forms are automatically provided to the reimbursement consultant who then seeks approval from the payer. Advantageously, approval for a treatment can be achieved with minimal effort on the part of the provider or user.

System 100 operates with a shared, secure database 113 that tracks and automatically updates the status of pre-authorization, denials, appeals, and other reimbursement adjudications for individual cases. Using the shared database, both the reimbursement consultant and the user can be informed of any progress.

After verifying insurance and/or gaining approval from a payer, the reimbursement consultant selects button 1251. Upon selection of button 1251, a user is notified that the insurance coverage has been verified. This verification generally includes a confirmation number from the payer. The user can be notified by any mechanism known in the art, such as, by e-mail or by automatically updating the Reimbursement Desktop at the user's location. Information provided in the user notification can be automatically provided from information previously provided to system 100 by the reimbursement consultant and/or user in the process of gaining approval.

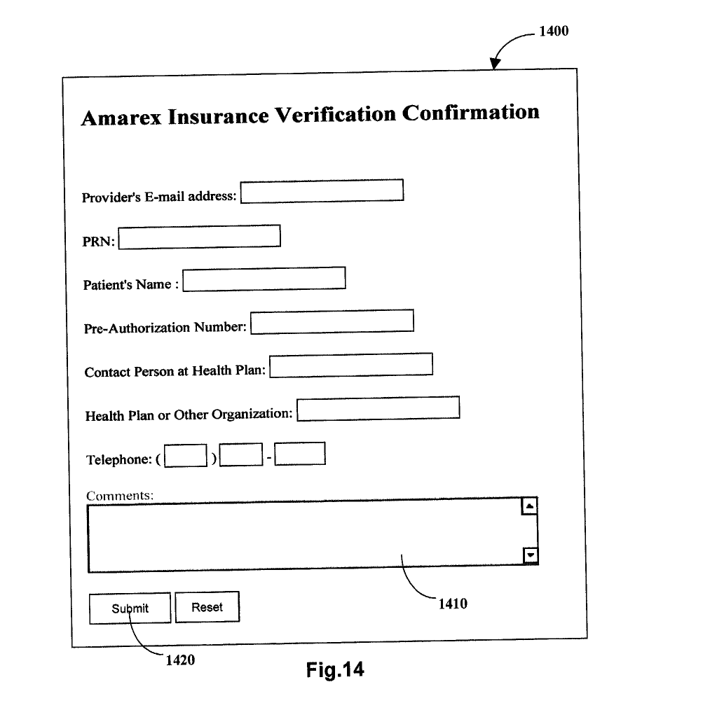

Alternatively, the reimbursement consultant may fill out a form, such as form 1400 illustrated in FIG. 14. Referring to FIG. 14, similar to previously described letters, fields of form 1400 can be automatically populated from information that is resident on database 113 or resident on database 153. In addition to providing approval related information, the reimbursement consultant can provide any additional comments necessary at comment field 1410. Upon completion of the fields, a submit button 1420 is selected. Submit button 1420 causes approval information to be communicated to the user, similar to button 1251.

Upon verifying insurance or other payment information, the user can request a refill of a treatment from a pharmacy by selecting hyperlink 1242 or order the treatment directly from a supplier, manufacturer, or other designated source by selecting hyperlink 1244. After verifying insurance, the reimbursement consultant selects button 1252 which communicates the authorization to the provider. The authorization is used by the provider to request the treatment from the supplier, manufacturer, and/or any other third party. If hyperlink 1244 is selected, a request for the product or for product shipment is sent by the provider via e-mail or otherwise communicated to manufacturer, supplier and/or shipper. Information in the notification can be automatically provided from information previously provided to system 100 by the reimbursement consultant and/or user in the process of gaining approval.

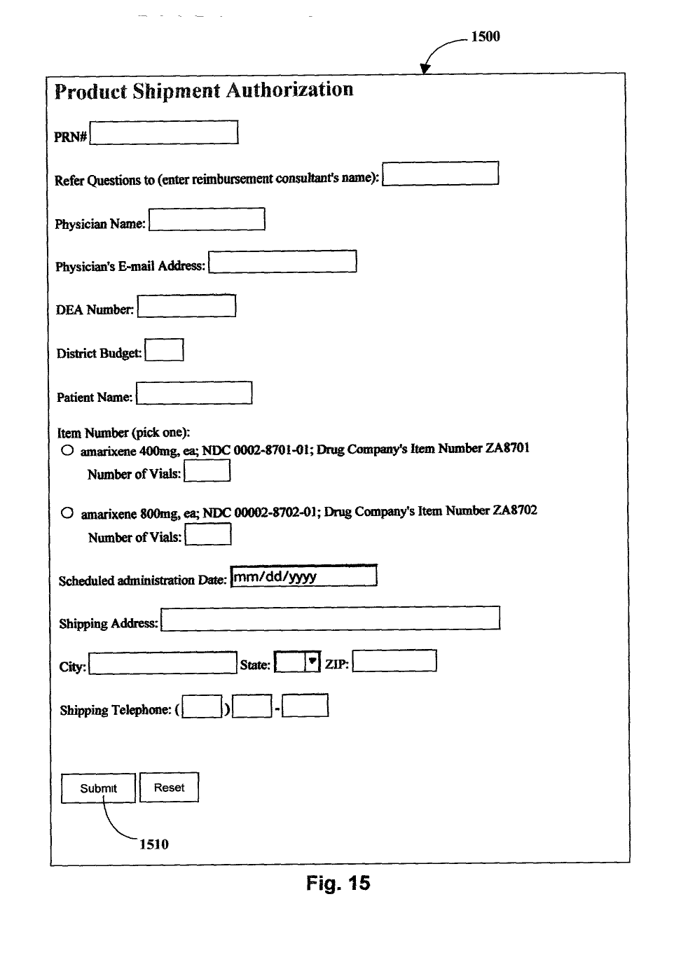

Alternatively, the reimbursement consultant may fill out a form, such as 1500 illustrated in FIG. 15. Referring to FIG. 15, similar to previously described letters, fields of form 1500 can be automatically populated where the required information is resident on system 100. Upon completion a submit button 1510 is selected. Submit button 1510 causes approval information to be communicated to the user, the supplier and/or manufacturer similar to button 1252

In some embodiments, a shipping company is notified to pick the order up from the supplier or manufacturer and deliver it to the user. Alternatively, the user may designate a third party delivery point where the shipper will deliver the treatment.

Thus, system 100 provides for authorizing the shipment of treatments online following coverage verification and ordering the shipment of treatments direct from the manufacturer to the provider. In some embodiments, the treatments supported include medications administered directly by a health care provider. Additionally, system 100 provides for access to clinical literature from drug compendia to support reimbursement claims for off-label drug uses.

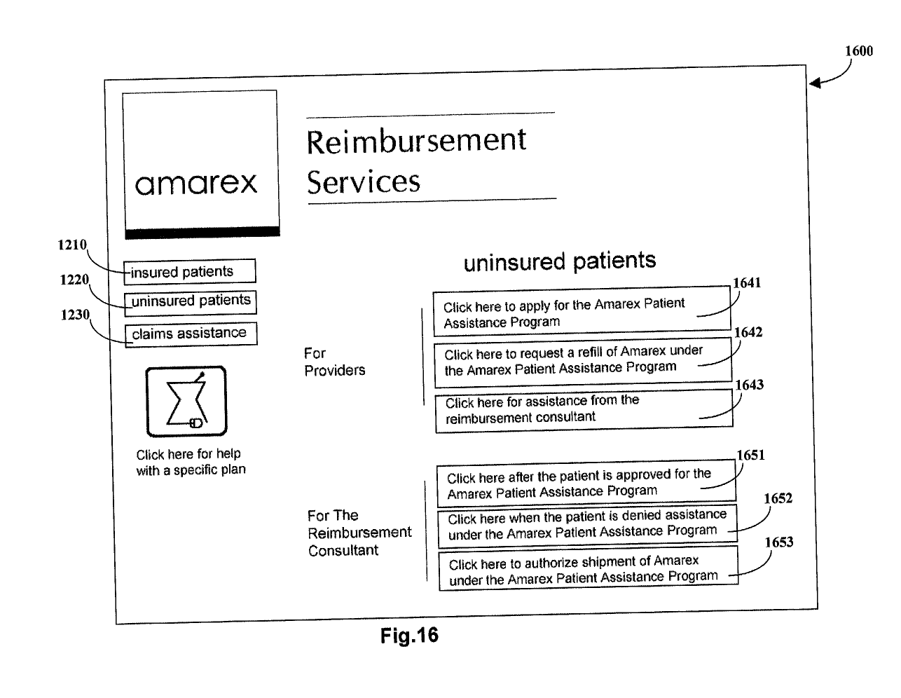

By selecting hyperlink 1220, a user is presented with Reimbursement Desktop 1600 illustrated in FIG. 16 and specific to uninsured patients. Referring to FIG. 16, Reimbursement Desktop 1600 includes a section 1640 for providers, and a section 1650 for reimbursement consultants. Section 1640 includes a hyperlink 1641 for access to complete and submit an application for an assistance program associated with a particular treatment, a hyperlink 1642 for access to a page to request a refill of the treatment under an assistance program, and a hyperlink 1643 to access a page to request assistance from a reimbursement consultant. Selecting hyperlink 1643 results in an e-mail being sent to the reimbursement consultant. The user and reimbursement consultant then communicate in an effort to determine if the user or patient should be granted approval for the assistance program.

Section 1650 includes a button 1651, which if selected, indicates that the patient is approved for the assistance program, a button 1652, which if selected, indicates the patient is denied assistance under the assistance program, and a button 1653, which if selected, indicates approval to ship an ordered treatment to an uninsured patient.

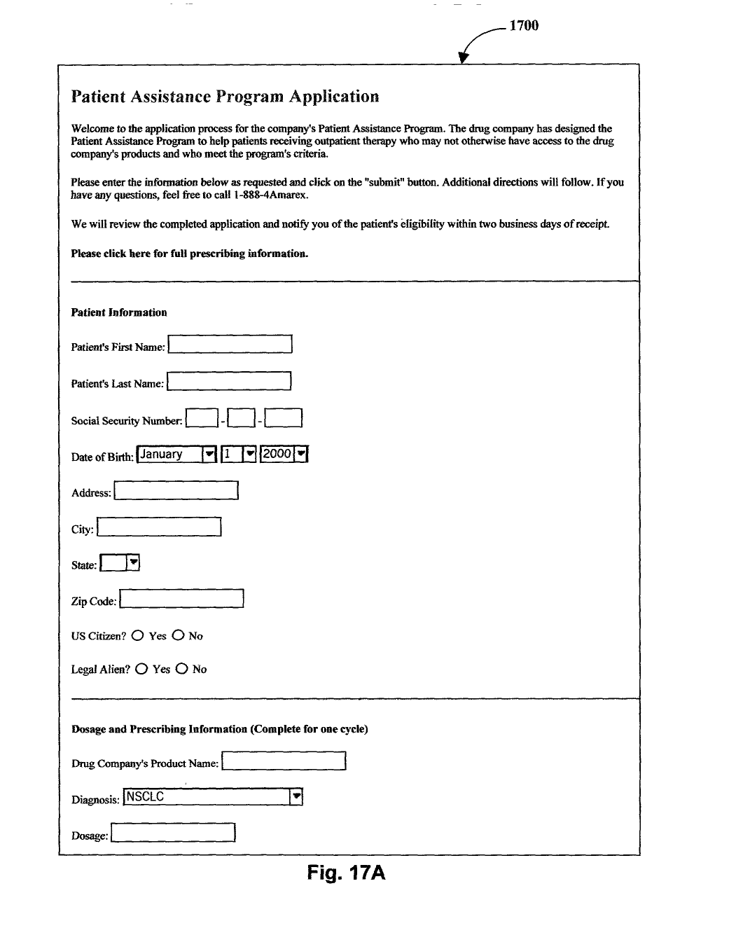

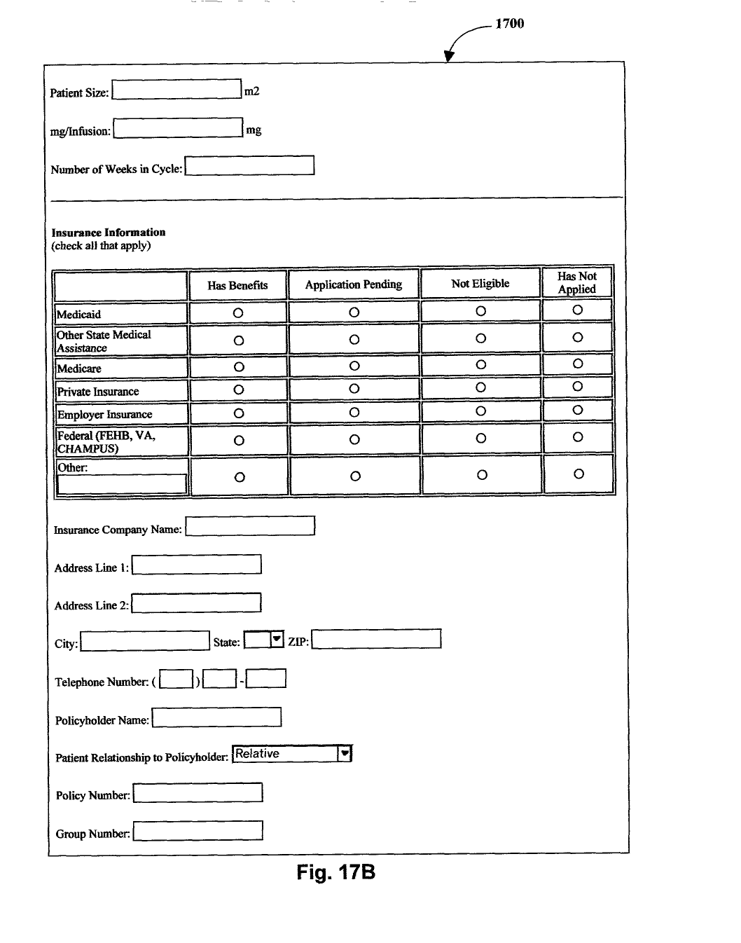

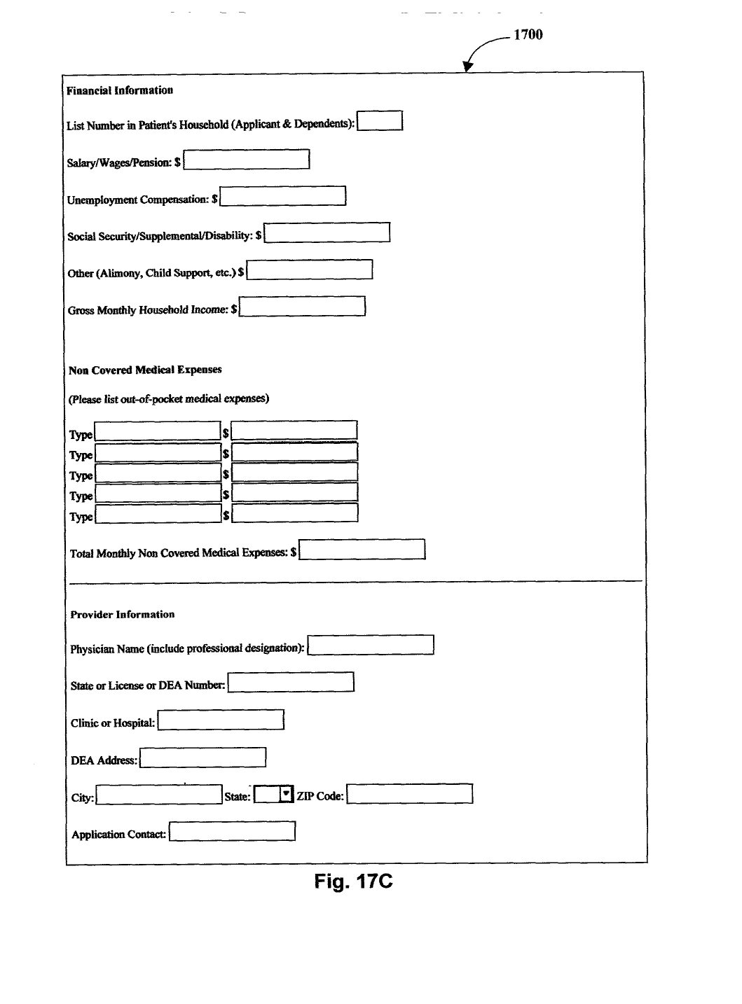

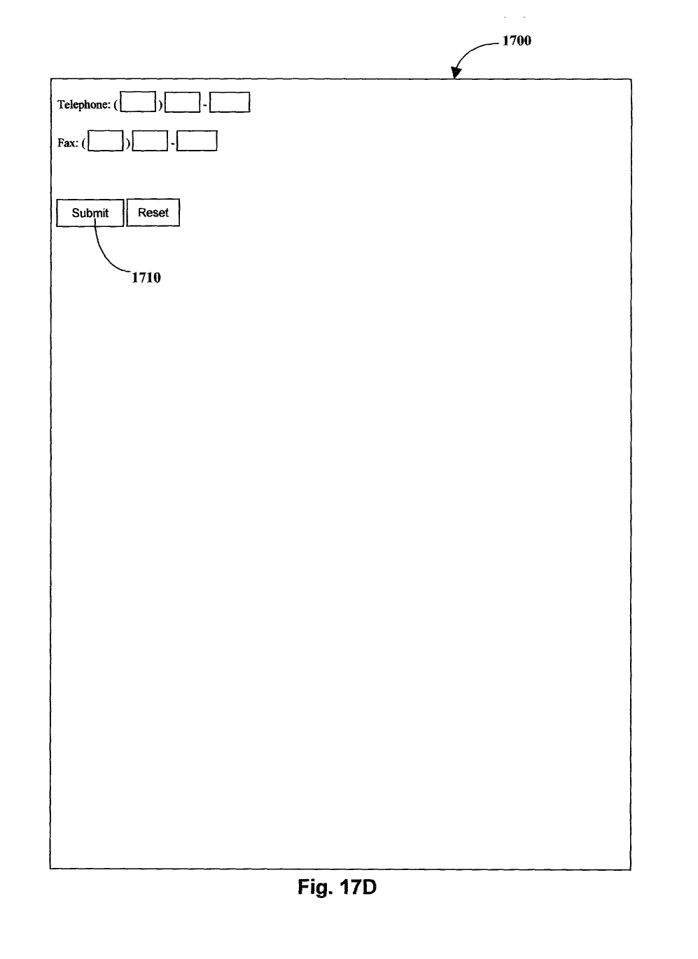

By selecting hyperlink 1641, a user is presented with a form for requesting access to any available assistance program corresponding to the selected treatment, for example, assistance programs offered by a supplier or manufacturer. In an embodiment, a form 1700, illustrated in FIGS. 17A-17D, may be used to request approval. The form can be automatically populated as previously discussed. Upon completing form 1700, the user causes the information to be communicated to the reimbursement consultant as previously discussed with reference to other letters.

Upon receiving information from form 1700, the reimbursement consultant either approves or denies the patients acceptance into the assistance program. To approve acceptance into the program, the reimbursement consultant selects button 1651 which causes a message indicating approval to be sent to the user. The message information is automatically populated from information maintained on system 100.

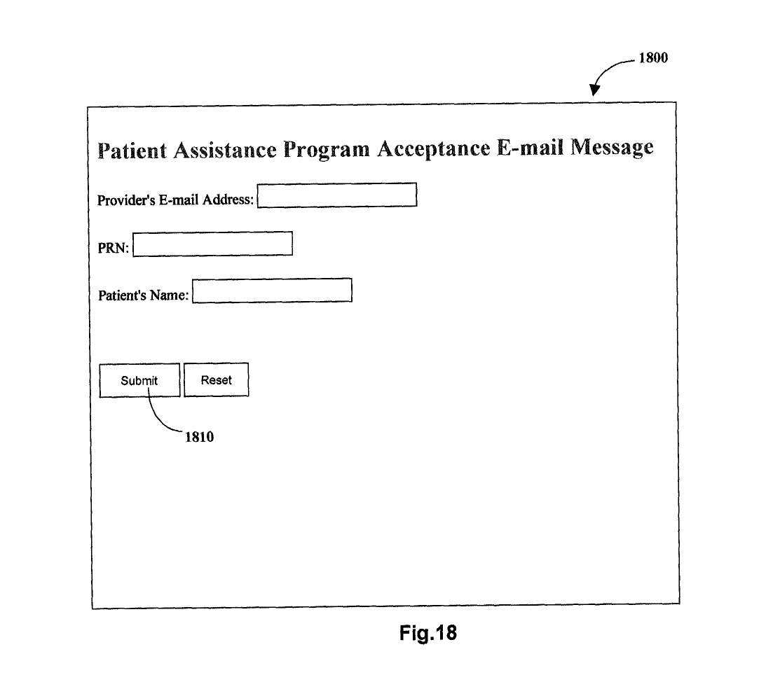

Alternatively, the reimbursement consultant may enter data in fields of form 1800 illustrated in FIG. 18. Once information is provided, the reimbursement consultant selects button 1810 causing an approval message to be communicated to the user.

Where the reimbursement consultant denies acceptance of the patient into the assistance program, the consultant selects button 1652 which causes a message indicating the denial to be sent to the user, for example via e-mail. The message information is automatically populated from information maintained on system 100.

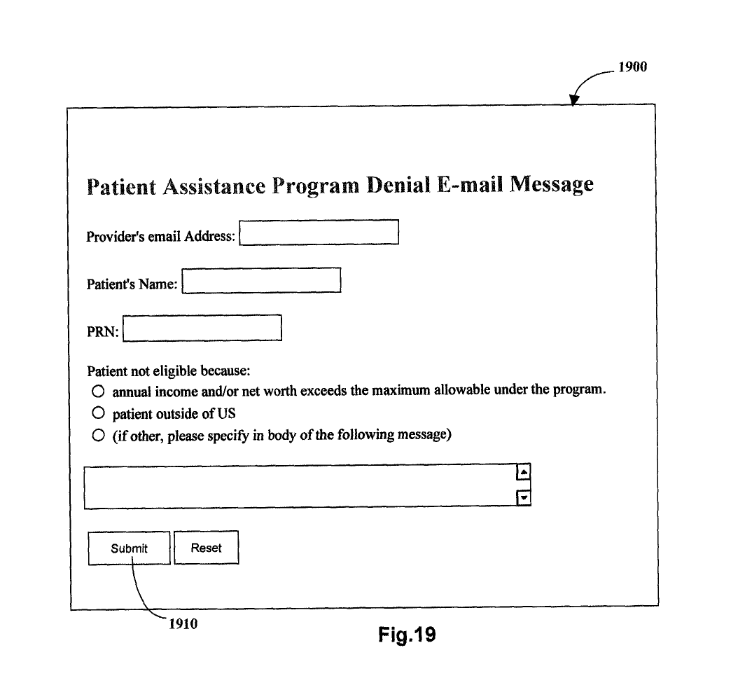

Alternatively, the reimbursement consultant may enter data in fields of form 1900 illustrated in FIG. 19. Once information is provided, the reimbursement consultant selects button 1910 causing an denial message to be communicated to the user, preferably via e-mail.

If a patient is approved for the assistance program, the provider may order an approved treatment by selecting button 1642. Selecting button 1642 causes an order to appear at the reimbursement desktop of the reimbursement consultant. The reimbursement consultant then verifies and approves the order. Once the order is verified and approved, the reimbursement consultant selects button 1653 which causes the order to be forwarded to the manufacturer and/or supplier similar to that previously discussed with relation to button 1252.

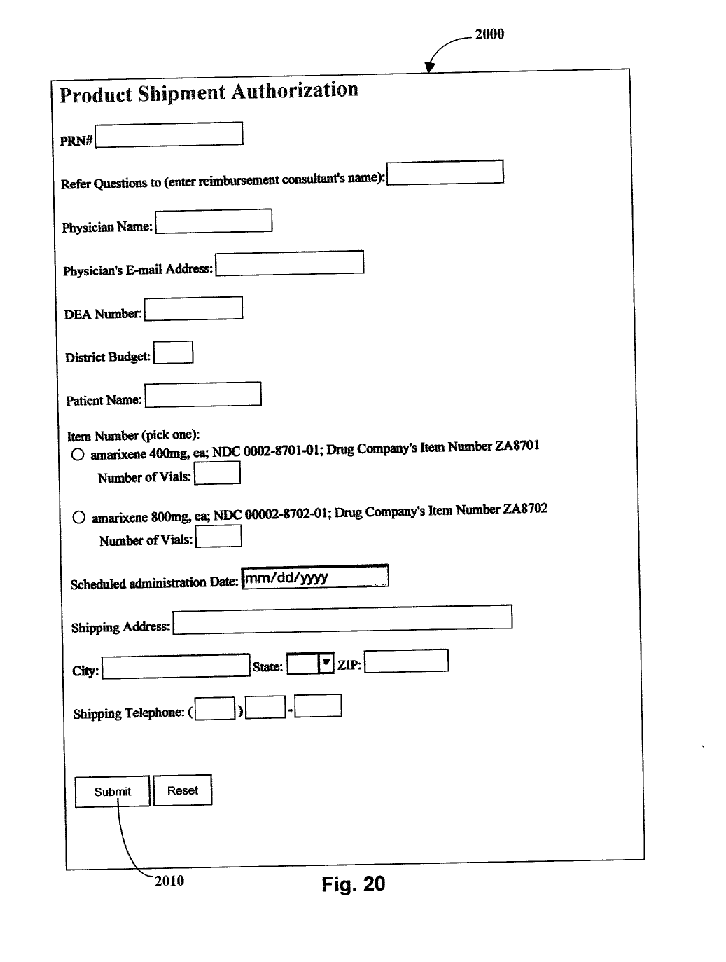

Alternatively, the reimbursement consultant may fill out a form, such as 2000 illustrated in FIG. 20. Once fields of the form are completed, a submit button 2010 is selected causing the order to be submitted as previously described in relation to submit button 1510.

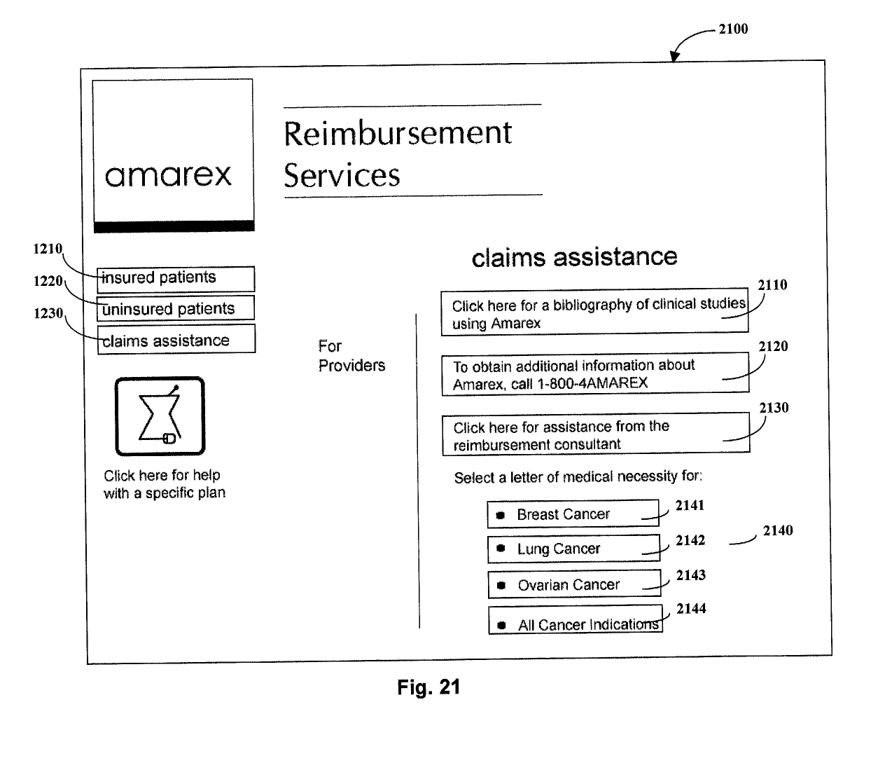

By selecting hyperlink 1230, a user is presented with an Internet page 2100, as illustrated in FIG. 21, providing claims assistance. Referring to FIG. 21, Internet page 2100 may comprise a number of fields including: a hyperlink 2110 to a bibliography of clinical studies using the selected treatment, a hyperlink 2120 for requesting additional information regarding the selected treatment, a hyperlink 2130 for initiating communication with a reimbursement consultant with information related to the selected treatment, and a section 2140 for selecting an LMN. Section 2140 includes buttons 2141, 2142, 2143 and 2144 for selecting a diagnosis for insertion into the LMN. Once the diagnosis is selected, an LMN is generated for the user as previously discussed. Information for the letter can be automatically populated as described with relation to FIGS. 7 and 8.

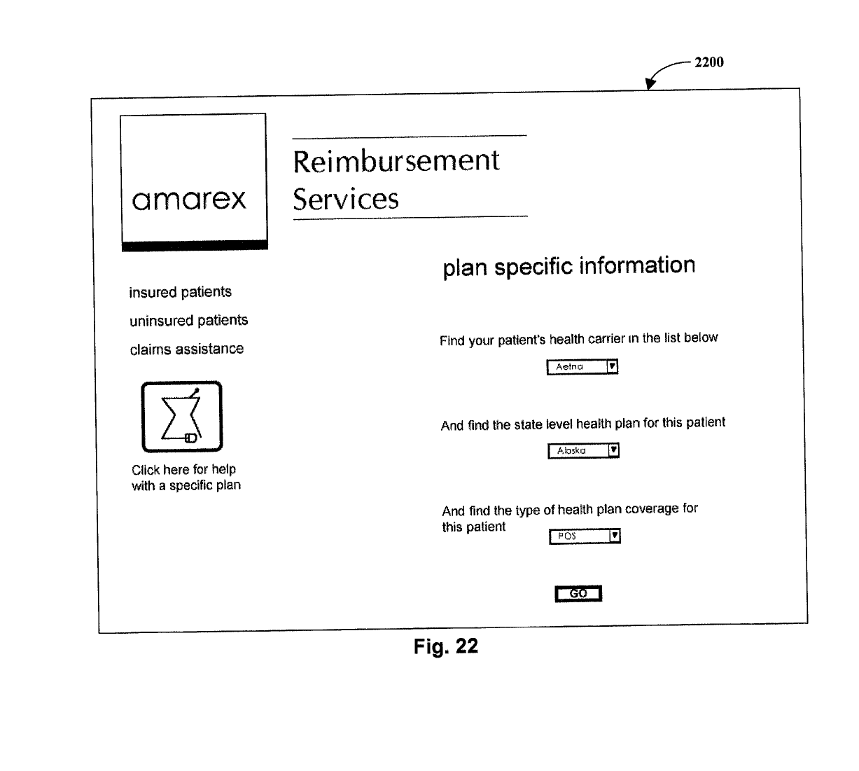

Additionally, a provider can be provided with payer specific information by entering a specific payer by way of form 2200 as illustrated in FIG. 22. Use of form 2200 is self evident.

While three levels of service have been described in accordance with the present invention, it should be recognized that any combination of services associated with system 100 can be combined according to the present invention.

In accordance with one embodiment of the present invention it is provided free to providers and consumers. Funding for the invention is provided from treatment manufacturers and/or suppliers, such as pharmaceutical companies. In accordance with another embodiment of the present invention, as an incentive to fund system 100, the Basic level of service related to a treatment is provided free. Expanded and Reimbursement level service may be provided for a financial consideration from the drug companies.

In accordance with yet another embodiment, user access to system 100 is provided via a password. The password is provided from a manufacturer or supplier of a treatment directly to a health care provider. This allows a manufacturer or supplier to promote their products directly to a health care provider while giving the health care provider an incentive to meet with the supplier and/or manufacturer.

Further compensation for the system may be provided by shippers who receive orders to ship various treatments. Additionally, orders can be forwarded to various bulk pharmacies who could provide compensation for the order flow. Further, an Internet site associated with system 100 could supply advertising and reap compensation from that source.

A further source of income may be any database developed using system 100. The database can include information on the frequency of denials compared with the frequency of approvals. Such frequencies could be based on a particular treatment and/or a particular payer. Statistical data could be maintained on treatments most likely to be denied and on the type of providers most likely to request a particular treatment. Such information may be valuable for making marketing and production decisions as well as for determining which payers are abusing the complexity of any reimbursement and approval system. To protect privacy, this statistical information is cleansed of all attributes capable of identifying a particular patient.

The present invention provides the systems and methods necessary to allow a care provider to select the optimal treatment. For example, the care provider may be provided with information regarding the differences between prescribed treatments and substitute treatments suggested by the payer. With this information, the care provider can make an objective decision on whether to use the suggested substitute treatment, or proceed with the prescribed treatment. In the case where the care provider desires the prescribed treatment, the present invention provides the care provider with the systems and methods for obtaining approval for the treatment.

Although the invention is described with reference to specific embodiments and figures thereof, the embodiments and figures are merely illustrative, and not limiting of the invention. Rather, the scope of the invention is to be determined solely by the appended claims.

What is claimed is:

1. A method for providing a payer attribute corresponding to a medical treatment from a system node to a user node, the method comprising:
receiving an indicator from the user node at the system node;
determining a payer attribute based on the indicator; and
communicating the payer attribute to the user node across a computer network.

2. The method for providing a payer attribute corresponding to a medical treatment from a system node to a user node, according to claim 1, wherein the indicator identifies a treatment.

3. The method for providing a payer attribute corresponding to a medical treatment from a system node to a user node, according to claim 2, wherein the payer attribute comprises a diagnosis which support the treatment.

4. The method for providing a payer attribute corresponding to a medical treatment from a system node to a user node, according to claim 2, wherein the treatment is a medical procedure.

5. The method for providing a payer attribute corresponding to a medical treatment from a system node to a user node, according to claim 2, wherein the treatment is a medication.

6. The method for providing a payer attribute corresponding to a medical treatment from a system node to a user node, according to claim 1, wherein the indicator identifies a payer.

7. The method for providing a payer attribute corresponding to a medical treatment from a system node to a user node, according to claim 6, wherein the payer is an insurance company.

8. The method for providing a payer attribute corresponding to a medical treatment from a system node to a user node, according to claim 6, wherein the payer attribute comprises a treatment commonly denied by the payer.

9. The method for providing a payer attribute corresponding to a medical treatment from a system node to a user node, according to claim 1, wherein the user node comprises a browser in communication with the Internet.

10. The method for providing a payer attribute corresponding to a medical treatment from a system node to a user node, according to claim 1, wherein the payer attribute comprises a payer requirement for approving a medical treatment.

11. The method for providing a payer attribute corresponding to a medical treatment from a system node to a user node, according to claim 1, wherein the payer attribute comprises a suggested substitute treatment.

12. The method for providing a payer attribute corresponding to a medical treatment from a system node to a user node, according to claim 11, wherein the payer attribute further comprises a difference between the suggested substitute treatment and a desired treatment.

13. The method for providing a payer attribute corresponding to a medical treatment from a system node to a user node, according to claim 12, wherein the payer attribute further comprises at least one diagnosis for which the suggested substitute treatment is less optimal than the desired treatment.

14. The method for providing a payer attribute corresponding to a medical treatment from a system node to a user node, according to claim 1, wherein the user node is operated by a patient.

15. The method for providing a payer attribute corresponding to a medical treatment from a system node to a user node, according to claim 1, wherein the user node is located at a physician's office.

16. The method for providing a payer attribute corresponding to a medical treatment from a system node to a user node, according to claim 1, wherein the user node is located at a pharmacy.

17. The method for providing a payer attribute corresponding to a medical treatment from a system node to a user node, according to claim 1, wherein the system node is a server in communication with the Internet.

18. The method for providing a payer attribute corresponding to a medical treatment from a system node to a user node, according to claim 1, wherein the system node is associated with a computer readable medium, the computer readable medium comprising:
treatment data associated with a treatment identifier;
payer data associated with a payer identifier; and
the payer attribute associated with a combination of the treatment identifier and the payer identifier.

19. The method for providing a payer attribute corresponding to a medical treatment from a system node to a user node, according to claim 18, wherein determining the payer attribute comprises:
associating the payer identifier with the medication identifier; and
retrieving the payer attribute associated with the medication identifier and payer identifier.

20. The method for providing a payer attribute corresponding to a medical treatment from a system node to a user node, according to claim 18, wherein the computer readable medium further comprises:
a first statistical datum associated with the payer identifier; and
a second statistical datum associated with the medication identifier.

21. The method for providing a payer attribute corresponding to a medical treatment from a system node to a user node, according to claim 1, the method further comprising:
receiving a request for access from a provider; and
providing the identity of the provider to a treatment supplier, wherein the treatment supplier provides the provider with a password.

22. The method for providing a payer attribute corresponding to a medical treatment from a system node to a user node, according to claim 1, wherein the indicator is a first indicator, the method further comprising:
receiving a second indicator from the user node at the system node.

23. The method for providing a payer attribute corresponding to a medical treatment from a system node to a user node, according to claim 22, the method further comprising:
providing a database interface at the user node, the database interface automatically retrieving one of the first or the second indicators from the user node and communicating the first and the second indicators to the system node.

24. The method for providing a payer attribute corresponding to a medical treatment from a system node to a user node, according to claim 22, wherein the first indicator identifies a treatment and the second indicator identifies a payer.

25. The method for providing a payer attribute corresponding to a medical treatment from a system node to a user node, according to claim 24, wherein the payer attribute is specific to both the payer and the treatment.

26. The method for providing a payer attribute corresponding to a medical treatment from a system node to a user node, according to claim 24, the method further comprising:
displaying an interface at the user node, wherein the first and second indicators are entered via the interface.

27. The method for providing a payer attribute corresponding to a medical treatment from a system node to a user node, according to claim 26, wherein the interface is an Internet page.

28. The method for providing a payer attribute corresponding to a medical treatment from a system node to a user node, according to claim 26, wherein the treatment is a medication and the interface is a first interface, the method further comprising:
providing a second interface at the user node, the second interface operable to receive an order for the medication;
receiving the order for the medication; and
ordering the medication.

29. The method for providing a payer attribute corresponding to a medical treatment from a system node to a user node, according to claim 28, the method further comprising:
communicating the order for the medication to a shipper.

30. The method for providing a payer attribute corresponding to a medical treatment from a system node to a user node, according to claim 29, the method further comprising:
receiving compensation from the shipper for communicating the order to the shipper.

31. The method for providing a payer attribute corresponding to a medical treatment from a system node to a user node, according to claim 26, wherein the interface is a first interface, the method further comprising:
providing a second interface at the user node for creating an approval request; and
communicating a created approval request to the payer.

32. The method for providing a payer attribute corresponding to a medical treatment from a system node to a user node, according to claim 31, wherein the second interface comprises an interactive letter.

33. The method for providing a payer attribute corresponding to a medical treatment from a system node to a user node, according to claim 31, wherein the second interface comprises a form letter.

34. The method for providing a payer attribute corresponding to a medical treatment from a system node to a user node, according to claim 31, the method further comprising:
receiving a response from the payer, the response denying the created approval request;
communicating the response to the user; and
providing a third interface at the user node for creating an appeal corresponding to the response.

35. The method for providing a payer attribute corresponding to a medical treatment from a system node to a user node, according to claim 31, wherein the second interface is an Internet page comprising a field for entering data.

36. The method for providing a payer attribute corresponding to a medical treatment from a system node to a user node, according to claim 35, wherein the Internet page comprises a radio button for selecting a diagnosis.

37. The method for providing a payer attribute corresponding to a medical treatment from a system node to a user node, according to claim 36, wherein the radio button is a first radio button and the diagnosis is a first diagnosis, and wherein:
the Internet page further comprises a second radio button for selecting a second diagnosis, the second diagnosis related to the first diagnosis.

38. The method for providing a payer attribute corresponding to a medical treatment from a system node to a user node, according to claim 26, wherein the interface is a first interface, the method further comprising:
providing a second interface at the user node for creating an approval appeal.

39. The method for providing a payer attribute corresponding to a medical treatment from a system node to a user node, according to claim 38, the method further comprising:
communicating the approval appeal to the payer.

40. A method for securing approval for a particular medical treatment, the method comprising:
providing a system node in communication with the Internet;
receiving at the system node a first indicator and a second indicator, the first indicator identifying a medication and the second indicator identifying a payer;
providing to a user node across the Internet a first interface for creating a request for approval corresponding to the first and second indicators.

41. The method for securing approval for a particular medical treatment, according to claim 40, wherein the first interface is an interactive letter.

42. The method for securing approval for a particular medical treatment, according to claim 40, wherein the first interface is a first Internet page.

43. The method for securing approval for a particular medical treatment, according to claim 40, the method further comprising:
receiving a created request for approval from the user node; and
communicating the created request for approval to the payer.

44. The method for securing approval for a particular medical treatment, according to claim 43, the method further comprising:
receiving a denial of the created request for approval, the denial comprising an indication of a treatment denied and the payer; and
providing to a user an appeal request corresponding to the denial.

45. The method for securing approval for a particular medical treatment, according to claim 44, wherein the appeal request is an interactive letter.

46. The method for securing approval for a particular medical treatment, according to claim 44, wherein the appeal request is created via an interactive Internet page.

47. The method for securing approval for a particular medical treatment, according to claim 44, wherein the appeal request comprises an electronic signature.

48. The method for securing approval for a particular medical treatment, according to claim 43, wherein the created request for approval comprises an electronic signature.

49. The method for securing approval for a particular medical treatment, according to claim 43, wherein communicating the created request for approval is done by facsimile.

50. A method for appealing a denial of a medical treatment by a payer to secure approval for the medical treatment, the method comprising:
receiving a denial of a request to approve a medical treatment; and
providing to a user across the Internet an appeal request corresponding to the denial of the request to approve.

51. A method of securing approval for a particular medical treatment from a payer, the method comprising:
operating a user node to provide an indicator to a system node, wherein the system node associated with a database, the database comprising:
a payer and an attribute associated with the payer, wherein the indicator selects the payer and the attribute;
receiving the attribute from the system node; and
receiving a customizable request for approval corresponding to the attribute.

52. A system for providing a payer attribute corresponding to a medical treatment to a user node in communication with a computer network, the system comprising:
a system node, the system node operable to perform the steps of claim 1.

53. A computer readable medium executable by a computer, the computer readable medium comprising:
program data, the program data executable by the computer to perform the steps of claim 1.

54. A system for securing approval for a medical treatment from a payer, the system comprising:
a system node in communication with the Internet, wherein the system node associated with a computer readable medium; and
the computer readable medium embodying an interactive request for approval of a medical treatment.

55. The system for securing approval for a medical treatment from a payer, according to claim 54, wherein the interactive request for approval is an interactive letter.
